(19) United States
(12) Patent Application Publication
(10) Pub. No.: US 2025/0225297 A1
(43) Pub. Date: Jul. 10, 2025

(54) GAS TURBINE ENGINE LIFECYCLE DIGITAL-TWIN DESIGN, MONITORING AND MAINTENANCE

(71) Applicant: University of South Carolina, Columbia, SC (US)

(72) Inventors: Jamil Khan, Columbia, SC (US); Sowmya Raghu, Columbia, SC (US)

(73) Assignee: University of South Carolina, Columbia, SC (US)

(21) Appl. No.: 18/943,059

(22) Filed: Nov. 11, 2024

Related U.S. Application Data
(60) Provisional application No. 63/618,982, filed on Jan. 9, 2024.

(51) Int. Cl. G06F 30/27; G06F 30/12; G06F 30/15; G06F 119/02; G06F 119/08

(52) U.S. Cl. CPC G06F 30/27; G06F 30/12; G06F 30/15; G06F 2119/02; G06F 2119/08

(57) ABSTRACT

Described herein are digital twin methods and systems integrating advanced computational algorithms and user-centric interfaces to transform the management of gas turbine engines, which provide comprehensive real-time analytics, extending beyond basic performance prediction, design, analysis and monitoring as well as capabilities for predictive maintenance, design and efficiency optimization, and fault diagnosis, all accessible to operators regardless of their expertise in turbine physics.

### TECHNICAL FIELD

The subject matter disclosed herein is generally directed to digital twin methods and systems integrating advanced computational algorithms and user-centric interfaces to transform the management of gas turbine engines, which provide comprehensive real-time analytics, extending beyond basic performance prediction, design, analysis and monitoring as well as capabilities for predictive maintenance, design and efficiency optimization, and fault diagnosis, all accessible to operators regardless of their expertise in turbine physics.

### BACKGROUND

Gas Turbine Engines (GTE) play a significant role in aircraft propulsion and power generation. The conventional Gas Turbine Engine Development and Monitoring Lifecycle (EDML) typically encompasses six stages: preliminary design, numerical analysis, prototyping and testing, manufacturing, systems integration, and subsequent systematic monitoring processes.

Gas Turbine Engines (GTE) have been predominantly used for power generation and aircraft propulsion. Increase in GTE efficiency of even 1% can lead to lowering the carbon footprint per unit of electricity generated while saving over $1 billion in fuel cost-savings over a ten-year period in the US and thus, keeping the maintenance cost and capital costs lower.[1] In the preliminary design phase, thermodynamic performance calculations are systematically executed to evaluate the component and system level efficiencies of the GTE and to establish design parameters for pivotal components, including compressors and turbines. The second stage involves conducting numerical analysis and simulations to refine design parameters, optimize performance at various design, off-design, steady-state and transient conditions. The next stage involves material design and manufacturing of prototypes for the iterative cycle of design, testing, and refinement involves a synergistic integration which demands a holistic approach to creating a design digital twin for gas turbine engines.

Accordingly, it is an object of the present disclosure to redefine the gas turbine engine design and development process by synergistically integrating design capabilities, real-time operational data, and predictive maintenance through the implementation of digital twins.

Citation or identification of any document in this application is not an admission that such a document is available as prior art to the present disclosure.

### SUMMARY

The above objectives are accomplished according to the present disclosure by providing in one instance, a graphical user interface (GUI) for prediction of device efficiencies and thrust. The GUI may include at least one machine learning module configured to compute essential parameters based on at least one operational data input from at least one device, wherein the GUI is designed to receive input of at least one operational parameter as well as configured to perform at least one thermodynamic analysis to determine at least one performance characteristic and the at least one performance characteristic is used by at least one machine learning algorithm contained within the at least one machine learning module to predict at least one efficiency factor and at least one performance factor. Further, the at least one operational parameter may be temperature and/or pressure. Additionally, the GUI may accept at least one user input including Revolutions Per Minute, Inlet Temperature, and/or Pressure. Furthermore, the at least one user input may be used by the at least one machine learning algorithm to predict efficiency of the device. Moreover, the at least one device may be at least one compressor and/or at least one turbine. Yet again, the GUI may determine at least one geometrical parameter that changes device performance. Again still, the GUI may provide device geometrical optimization to shape the at least one device to increase the at least one efficiency factor and/or the at least one performance factor. Yet further, the GUI may provide at least one real-time analytic of the at least one device. Furthermore, the GUI may provide at least one predictive maintenance indicator for the at least one device. Yet further, the GUI may incorporate at least one digital twin system.

In a further instance, the current disclosure provides a system for prediction of device efficiencies and thrust. The system may include at least one graphical user interface (GUI), at least one physics based machine learning module configured to compute essential parameters based on at least one operational data input from at least one device, wherein the GUI may be configured to receive input of at least one operational parameter and may be further configured to perform at least one thermodynamic analysis to determine at least one performance characteristic of the at least one device and the at least one performance characteristic may be used by at least one machine learning algorithm contained within the at least one physics based machine learning module to predict at least one efficiency factor and at least one performance factor of the at least one device. Further, the at least one operational parameter may be temperature and/or pressure. Moreover, the GUI may accept at least one user input including Revolutions Per Minute, Inlet Temperature, and/or Pressure. Still again, the at least one user input may be used by the at least one machine learning algorithm to predict efficiency of the device being review. Yet further, the at least one device may be at least one compressor and/or at least one turbine. Still yet further, the GUI may determine at least one geometrical parameter that changes performance of the at least one device. Again, the GUI may provide device geometrical optimization to shape the device to increase the at least one efficiency factor and/or the at least one performance factor of the at least one device. Further still, the GUI may provide at least one real-time analytic of the at least one device. Yet still, the GUI may provide at least one predictive maintenance indicator for the at least one device. Still moreover, the GUI may incorporate at least one digital twin system.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a flow chart of Motivation for Development of GTE-DMT.

FIG. 2 shows Table 1.

FIG. 3 shows a diagram of location of points at which velocities and thermodynamic states are calculated.

FIG. 4 shows a velocity triangle at impeller inlet.

FIG. 5 shows a flow diagram of the iterative procedure at the impeller inlet.

FIG. 6 shows a velocity triangle at impeller outlet.

FIG. 7 shows a flow diagram of the iterative procedure at the impeller outlet.

FIG. 8 shows a velocity triangle at the vaned diffuser inlet.

FIG. 9 shows a nomenclature of stations used for the turbine.

FIG. 10 shows a velocity diagram of the axial turbine stage.

FIG. 11 shows a flow diagram of the iterative procedure at the nozzle inlet.

FIG. 12 shows a flow diagram of the iterative procedure at the rotor outlet.

FIG. 13 shows a flow chart of one example of an engine design and monitoring lifecycle.

FIG. 14 shows an SR-30 and TG-2000 TurboGen Gas Turbine Engine Experimental Setup of the current disclosure.

FIG. 15 shows an SR-30 and TG-2000 TurboGen Gas Turbine Engine Cutaway.

FIG. 16 shows an SR-30 Gas Turbine Engine Exploded view.

FIG. 17 shows Table 2-TurboGen System Sensor Information.

FIG. 18 shows an SR-30 Gas Turbine Engine stage-wise measurement locations.

FIG. 19 shows a graph of Compressor Inlet and Exit Pressure.

FIG. 20 shows a graph of Compressor Inlet and Exit Temperature.

FIG. 21 shows a graph of Operational Compressor Pressure Ratio using Jet A fuel.

FIG. 22 shows a graph of Turbine Inlet and Exit Pressure.

FIG. 23 shows a graph of Turbine Pressure Ratio.

FIG. 24 shows a graph of Turbine Inlet and Exit Temperature.

FIG. 25 shows a graph of SR30 GTE Overall Thrust vs RPM.

FIG. 26 shows a Correlation Matrix from the Operational Data of the TurboGen system.

FIG. 27 shows a Correlation Matrix from the Operational and Computed Data of the TurboGen system Compressor.

FIG. 28 shows a Correlation Matrix from the Operational and Computed Data of the TurboGen system Turbine.

FIG. 29 shows a Correlation Matrix from the Operational and Computed Data of the TurboGen system Efficiencies.

FIG. 30 shows a plot of ANN Prediction for Turbine Efficiency.

FIG. 31 shows a plot of Random Forest Prediction for Turbine Efficiency.

FIG. 32 shows a plot of Polynomial Prediction for Turbine Efficiency.

FIG. 33 shows a plot of Gradient Descent Prediction for Compressor Efficiency.

FIG. 34 shows a plot of Random Forest Prediction for Compressor Efficiency.

FIG. 35 shows a plot of Robust Regression Prediction for Compressor Efficiency.

FIG. 36 shows a GUI startup window of the current disclosure.

FIG. 37 shows a GUI user input interface of the current disclosure.

FIG. 38 shows a plot of GUI Operational Data Output.

FIG. 39 shows one example of a GUI Prediction of compressor efficiency based on user input.

FIG. 40 shows Table 3-Hyperparameter Tuning and Optimization Overview for Various ML Models.

FIG. 41 shows Table 4-Predictive Statistical Metrics for Compressor Efficiency.

FIG. 42 shows Table 5-Predictive Statistical Metrics for Turbine Efficiency.

FIG. 43 shows Table 6-Predictive Statistical Metrics for Thrust.

FIG. 44 shows at (a) Radial Compressor Numerical Analysis and at (b) Axial Turbine Numerical Analysis for a Velocity Profile of the SR-30 Turbomachines.

FIG. 45 shows a graph of mass flow versus pressure ratio for quantifying surge and choke margins.

FIG. 46 shows illustrations of transient structural analysis.

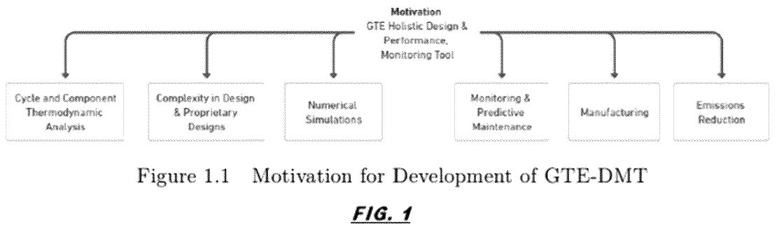

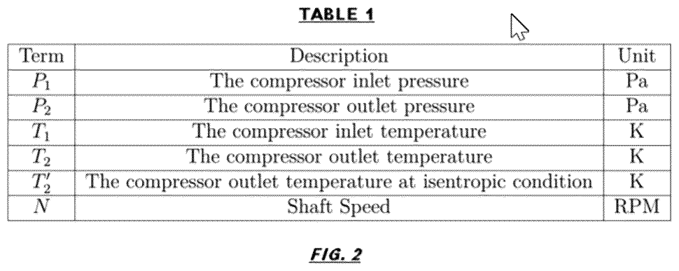

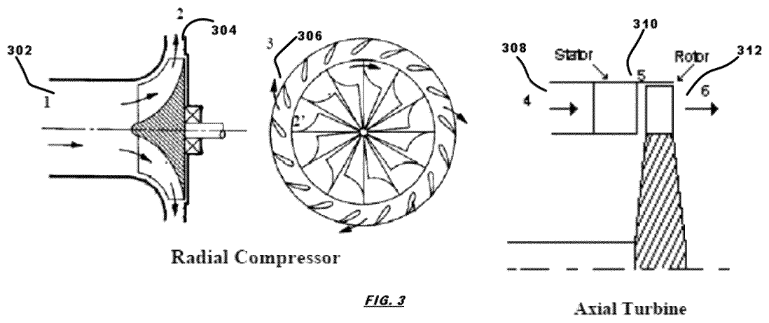

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the digital twin methods and systems described herein can be presented as a combination kit. As used herein, the terms “combination kit” or “kit of parts” refers to the devices, systems, and any additional components that are used to package, sell, market, deliver, and/or provide administer the combination of elements or a single element, such as digital twin methods and systems described herein, contained therein. Such additional components include, but are not limited to, packaging, blister packages, and the like. When one or more of the devices, systems, and any additional components described herein or a combination thereof (e.g., materials contained in the kit are provided simultaneously, the combination kit can contain the digital twin methods and systems in a single embodiment or in separate embodiments. When the devices, systems, and any additional components described herein or a combination thereof and/or kit components are not provided simultaneously, the combination kit can contain each device, systems, and any additional components separate embodiments. The separate kit components can be contained in a single package or in separate packages within the kit.

In some embodiments, the combination kit also includes instructions printed on or otherwise contained in a tangible medium of expression. The instructions can provide information regarding the content of devices, systems, and any additional components, safety information regarding the content of the devices, systems, and any additional components, information regarding testing, indications for use, and/or recommended analysis regimens for the digital twin methods and systems contained therein. In some embodiments, the instructions can provide directions and protocols for applying and using the digital twin methods and systems described herein. In some embodiments, the instructions can provide one or more embodiments of the methods for testing of the digital twin methods and systems thereof such as any of the methods described in greater detail elsewhere herein.

The Gas Turbine Engine-Design and Monitoring Tool (GTE-DMT) stands at the forefront of turbine technology, integrating advanced computational algorithms and user-centric interfaces to transform the management of gas turbine engines. This sophisticated tool is crafted to provide comprehensive real-time analytics, extending beyond basic performance prediction, design, analysis and monitoring. It boasts capabilities for predictive maintenance, design and efficiency optimization, and fault diagnosis, all accessible to operators regardless of their expertise in turbine physics.

GTE-DMT's robust framework allows for the integration of a wide array of input operational parameters such as RPM, pressure ratios, and temperature readings, which is used to compute critical performance indicators like fuel efficiency, thrust, power output, and wear-and-tear predictions. This data-driven approach enables the tool to offer actionable insights for optimizing operational parameters, thereby enhancing the engine's lifespan and reducing downtime.

Additionally, GTE-DMT is designed with a modular concept, offering a ‘plug and play’ feature that facilitates seamless adaptation to different turbine models and operational environments. Its ability to interface with existing control systems and adapt to new data inputs makes it a versatile solution adaptable to evolving technological advancements in turbine engine design and operation.

Furthermore, GTE-DMT includes advanced features such as real-time data visualization, customizable alert systems for potential issues, and historical data analysis for long-term performance tracking. This amalgamation of features positions the GTE-DMT as a pivotal tool in the realm of gas turbine engine management, catering to the nuanced needs of modern-day turbine operation and maintenance.

This innovation centers on the creation of a specialized Digital Twin for Small Scale Gas Turbine Engines, offering a range of vital capabilities:

1. Performance Prediction: The Digital Twin is equipped to predict the thermodynamic performance of the gas turbine engine by using performance maps and/or operational data. This predictive functionality provides a comprehensive understanding of how the engine functions across various operating conditions, aiding in performance optimization.

2. Design Optimization: The Digital Twin actively engages in the optimization of component-level design using commercially available numerical software's to improve component/system level efficiency leveraging an inverse-design methodology.

3. Health Monitoring: Real-time monitoring and predictive maintenance are key features of this innovation. It continuously evaluates the health of the gas turbine engine by analyzing operational data. By constantly monitoring critical operational parameters, the system can promptly detect any irregularities or anomalies in engine performance. This proactive approach facilitates timely maintenance interventions, minimizing downtime and ensuring the engine's reliability.

4. Emission Management Expertise: The innovation integrates an expert system specifically designed for emissions management. This expert system utilizes its knowledge base (performance predictions and real-time operational data) to closely track emissions generated by the engine and provides recommendations for reducing emissions by altering the operational parameters. This environmental focus contributes to sustainable operations and aligns with eco-friendly objectives.

This interconnected cycle of prediction, optimization, monitoring, of gas turbine engine parameters along with emissions management leads to a self-improving system where each step contributes to the modification and enhancement of the others, resulting in a more efficient, reliable, and environmentally friendly gas turbine engine.

The GTE-DMT, as a Digital Twin, revolutionizes the conventional Design-Prototype-Production cycle in gas turbine engineering. Firstly, it significantly accelerates the preliminary design phase by enabling real-time simulation and analysis, thereby reducing the need for multiple physical prototypes and extended lifecycle of development. This iterative virtual design process leads to substantial cost and time-savings. Additionally, GTE-DMT enhances accuracy and efficiency by allowing for detailed performance prediction and optimization before physical production begins. GTE-DMT also offers operational insights real-time in order to troubleshoot issues and provide suggestions for preventative/predictive maintenance. By minimizing risks associated with traditional prototyping and streamlining the design process, GTE-DMT emerges as a superior tool, offering a competitive edge in developing more efficient, reliable, faster and cost-effective gas turbine engines.

This disclosure redefines the gas turbine engine design and development process by synergistically integrating design capabilities, real-time operational data, and predictive maintenance through the implementation of digital twins. The primary objective is to develop a modular, plug-and-play software for gas turbine turbomachinery components, facilitating integration of thermodynamic design, design and performance optimization through advanced numerical analysis, prototype development, process monitoring, emissions forecasting, and comprehensive lifecycle management. This approach aims to significantly enhance the efficiency, performance, and reliability of gas turbine engines by leveraging the digital twin technology across the entire EDML.

To develop the digital twin and validate its capabilities, empirical studies are conducted with the SR-30 small scale gas turbine engine at the Midlands Tech Northeast Campus. The data gathered from the experiments with different fuels, including Jet-A, Jet-B, and Kerosene is used to determine the operational component and system level efficiency in transient, design and off-design conditions. Numerical analysis of the SR-30's centrifugal compressor and axial turbine are conducted using ANSYS tools such as BladeGen, coupled with ANSYS-CFX, for multi-parameter turbomachinery design optimization. Data acquired through the operational testing and numerical analysis of SR-30 gas turbine engine are used in the development of physics-based machine learning models for accurate efficiency prediction of turbomachinery components. Based on numerical simulations, inverse aerodynamic modeling machine learning techniques are applied to iteratively generate and refine new design profiles for turbine and compressor blade geometries, which are subsequently used to study performance characteristics.

To broaden the scope of the research beyond the SR-30 Gas Turbine Engine (GTE), additional data were generated using the GasTurb software for various turbojet engines to obtain the compressor and turbine maps. This data facilitates the development an analytical framework is developed to enable a comprehensive thermodynamic evaluation of fluid flow, heat transfer, and energy interactions by utilizing the control volume approach in gas path analysis, focusing predominantly on turbomachinery components. By integrating operational data, insights from compressor and turbine maps, and data from literature and experiments, physics-based machine learning algorithms are developed to predict compressor and turbine efficiencies.

Thus, the novel Gas Turbine Engine-Design and Monitoring Tool (GTE-DMT), a state-of-the-art Digital Twin software, is designed to traverse the Gas Turbine Engine Development and Monitoring Lifecycle (EDML) by integrating capabilities for preliminary design, gas path analysis, efficiency optimization, detailed turbomachinery component design, health monitoring, emissions and fault diagnostics.

Gas turbine Engines (GTE) are highly complex machines which demand a deep understanding of aerodynamics, thermodynamics, fluid dynamics combustion processes, and material considerations, to name a few. GTEs exhibit nonlinear operational behavior, and, with an extended life cycle of development due to complexity in design and monitoring, challenges arise in performance prediction and optimization at both the component and system levels. These challenges emerge in the following areas:

### 1. Thermodynamic Analysis

Gas turbine engine efficiency is highly dependent on thermodynamic conditions. Challenges arise in optimizing performance under varying loads and environmental conditions, specifically in addressing isentropic efficiency. Industrial practices involve sophisticated thermodynamic cycle analyses, often utilizing Brayton cycle models, to optimize performance across different operating conditions.

### 2. Complexity in Design and Proprietary Designs

Designing a GTE component is a multidisciplinary task that requires consideration of various design criteria such as aerodynamics, materials, heat management, vibration, and related factors. Gas turbine designs are often proprietary to manufacturers, with the design specifications often considered as trade secrets. This proprietary nature limits the accessibility of crucial details, hindering academic or external efforts to fully comprehend and optimize the engines. It poses an obstacle for engineers to reverse engineer to enhance and optimize existing designs for performance.

### 3. Numerical Simulations

Numerical simulations play a crucial role in understanding and optimizing gas turbine design and performance. Gas turbine engines are subjected to dynamic conditions, characterized by variations in load, temperature, and pressure. Predicting and optimizing performance under these conditions necessitates sophisticated modeling and simulation techniques. These simulations require accurate representation of the component geometry which are unique to every engine.

These engine specific designs pose challenges in generalizing the design methodology to predict performance. Pre-existing designs and validated models are crucial for ensuring the accuracy and validity of the simulations and to capture the operational dynamics at a component and system level.

### 4. Monitoring and Predictive Maintenance

GTE monitoring involves deploying sensors to measure parameters like temperatures, pressures, emissions, vibration and other relevant factors. Predictive maintenance relies on these operational data, preferably real-time, to detect anomalies to indicate presence of potential faults and malfunctions. Prognostics and Health Management (PHM) techniques for GTEs are complicated due to the unpredictable nature of the operating conditions such as high temperatures and speeds. The sensor selection, installation, placement and maintenance directly affect the system's reliability. There are also inherent challenges in employing machine learning algorithms for data analysis and predictive maintenance due to the non-linearity and interdependence of the component's parameters.

### 5. Manufacturing

Gas turbine manufacturing poses numerous challenges, encompassing aspects such as material selection, fabrication, machining methods, quality control, testing and considerations of airworthiness. The use of advanced materials, including high-temperature alloys and intricate cooling schemes especially turbomachines add additional complexity to the manufacturing process. Quality control measures with non-destructive testing methods, like ultrasonic and X-ray inspections, playing a crucial role in detecting any defects or inconsistencies in the manufactured components especially with additively manufactured components used in novel GTEs. A high level of precision is required to ensure the production of reliable and high-performance gas turbine engines.

### 6. Emissions Reduction

The challenges associated with GTE emissions revolve around mitigating environmental impact and meeting strict regulatory standards. Achieving lower nitrogen oxides (NOx), carbon dioxide (CO2) emissions, is critical as it involves effective design to allow complete combustion. Thus, maintaining a balance between emissions standards and maintaining fuel efficiency requires trade-offs to effectively optimize both environmental and operational performance.

In order to tackle these challenges, implementation of a holistic design and performance tool becomes indispensable for capturing the interdependencies of operational characteristics in GTEs. Amidst the transition to Industry 4.0, the utilization of a digital twin for the design and monitoring process is essential. This approach establishes a virtual system that precisely depicts the dynamics of gas turbines, facilitating real-time performance prediction, preventative maintenance, and optimization. The decision to adopt a digital twin is evident and offers clear advantages. The design of a digital twin requires exploration of operational parameters, such as pressure, temperature, etc.; design parameters such as blade angles, vane thickness, tip clearance, etc.; manufacturing such as dimensional accuracy, material specification, etc.; emission estimation such as Nitrogen Oxides (NOx) levels, Hydrocarbon (HC) levels, etc.; and monitoring parameters such as vibration, component wear, etc. for the development of the holistic design and monitoring tool. The primary requirements for industrial applications for GTE-Design and Monitoring Tool (DMT) are as follows:

1. Accurate thermodynamic modeling to estimate component and system level efficiencies.

2. Versatile design tool for GTE components through extensive multi-parameter exploration and optimization.

3. Seamless integration of the design and performance computation process including but not limited to inverse design with sensitivity analysis and uncertainty quantification.

4. Monitoring emissions, vibration, etc. through the use of real-time information using sensors and IOT devices.

5. Leverage data-driven methodology to enable proactive fault and wear detection, predictive monitoring and condition maintenance.

However, conventional analytical methods and commercially available finite element software have fallen short in meeting these specific requirements. Hence, there is a critical need to develop accurate, efficient, and adaptable computational modeling framework that seamlessly integrates with advanced predictive modeling for the purpose of designing, predicting the performance, and monitoring the State-of-Health (SOH) of GTEs.

The current disclosure develops an efficient, versatile and holistic tool for Gas Turbine Engine design, performance and monitoring. The scope of the research covers the theoretical and mathematical modeling, numerical finite element simulation, experimental methodology and machine learning based GTE design, performance and monitoring tool. The objectives of the work presented in this disclosure are as follows:

1. To develop a novel thermodynamics-based performance and design tool for Gas Turbine Engine components.

2. To conduct experiments using SR-30 small scale GTE to map the operational envelope under diverse conditions using various fuels.

3. To conduct numerical analysis using ANSYS CFX on turbomachines, followed by employing machine learning techniques for parametric optimization based on inverse aerodynamic design.

4. To incorporate machine learning techniques to use operational data for system level performance prediction.

5. To integrate emissions, vibrations, fault diagnostics and other condition monitoring across various GTE components, operational parameters are utilized. This facilitates the comprehensive simulation of GTE maintenance and system management.

6. To create a universal Gas Turbine Engine-Design and Monitoring Tool GTE-DMT that interconnects physical entities, simulated entities, virtual entities, and their data, thus forming an integration between the virtual and physical realms.

The adiabatic efficiency (ηadiabatic) is calculated using the following formula:

$${η}_{adiabatic} = \frac{{h}_{isentropic , out} - {h}_{inlet}}{{h}_{actual , out} - {h}_{inlet}} \qquad ( 2.1 )$$

In terms of pressure ratio (P R), the isentropic relation between pressure and specific volume is used:

$${h}_{isentropic , out} = {h}_{inlet} + \frac{( γ - 1 ) \cdot {c}_{p} \cdot {T}_{inlet}}{γ} ( 1 - {( \frac{1}{PR} )}^{\frac{γ}{γ - 1}} ) \qquad ( 2.2 )$$

where hisentropic,out is the specific enthalpy at the compressor outlet assuming isentropic compression, cp is the specific heat at constant pressure, Tinlet is the temperature at the compressor inlet and γ is the ratio of specific heats

$$( \frac{{c}_{p}}{{c}_{υ}} ) .$$

$$ρ = \frac{P}{RT} \qquad ( 2.3 )$$

$$υ = \sqrt{\frac{2 P}{ρ}} \qquad ( 2.4 )$$

$$Q = A \cdot v \qquad ( 2.5 )$$

$$\dot{m} = ρ \cdot A \cdot V \qquad ( 2.6 )$$

$$T = \dot{m} \cdot V \qquad ( 2.7 )$$

$$M = \frac{V}{\sqrt{γ RT}} \qquad ( 2.8 )$$

$$Air fuel ratio = \frac{{\dot{m}}_{a}}{{\dot{m}}_{f}} \qquad ( 2.9 )$$

$$Isentropic Efficiency , {η}_{compressor} = \frac{{h}_{2}^{′} - {h}_{1}}{{h}_{2} - {h}_{1}} \qquad ( 2.1 )$$

$${Q}_{add} = {h}_{3} - {h}_{2} \qquad ( 2.11 )$$

$${η}_{Combustion Chamber} = \frac{\dot{m} ( {h}_{out} - {h}_{in} )}{{\dot{m}}_{f} \cdot {C}_{υ}} \qquad ( 2.12 )$$

$${\dot{m}}_{a} \cdot {C}_{P} \cdot ( {T}_{2} - {T}_{1} ) = ( {\dot{m}}_{a} + {\dot{m}}_{f} ) \cdot {C}_{P} \cdot ( {T}_{3} - {T}_{4} ) \qquad ( 2.13 )$$

$$Isentropic Efficiency , η = \frac{{h}_{3} - {h}_{4}}{{h}_{3} - {h}_{4}^{′}} \qquad ( 2.14 )$$

By selecting appropriate control volumes (e.g. compressor, combustor, turbine, nozzle) and applying these assumptions, the equations of mass and energy conservation and an entropy balance produce,

$$\sum {\dot{m}}_{in} = \sum {\dot{m}}_{out} \qquad ( 2.15 )$$

$$\dot{Q} - \dot{W} = \sum {\dot{m}}_{out} [ {h}_{out} + \frac{{V}_{out}^{2}}{2} ] - \sum {\dot{m}}_{in} [ {h}_{in} + \frac{{V}_{out}^{2}}{2} ] \qquad ( 2.16 )$$

$$0 = {\sum }_{j} \frac{{\dot{Q}}_{j}}{{T}_{b}} + \sum {\dot{m}}_{in} \cdot {S}_{in} - \sum {\dot{m}}_{out} \cdot {S}_{out} + \dot{σ} \qquad ( 2.17 )$$

where the subscript j represents the discrete locations on the control volume where the heat transfer occurs; Tb is the temperature at that boundary, and \dot{σ} is internal irreversibility. Every component except the combustor is assumed to be adiabatic and hence Q=0.

The power required by an adiabatic compressor is determined by the expression:

$${\dot{W}}_{c} = {\dot{m}}_{a} ( {h}_{t 1} - {h}_{t 2} ) \qquad ( 2.18 )$$

Similar to the compressor, the turbine power developed is determined by the expression:

$${\dot{W}}_{T} = ( {\dot{m}}_{a} + {\dot{m}}_{f} ) ( {h}_{t 3} - {h}_{t 4} ) \qquad ( 2.19 )$$

Engine thrust is the difference of the products of the intake mass flow and velocity and the exit mass flow and velocity, which when assuming no pressure thrust takes the form:

$${T}_{x} = ( {\dot{m}}_{a} + {\dot{m}}_{f} ) \cdot {V}_{5} - ( {\dot{m}}_{a} ) \cdot {V}_{aircraft} \qquad ( 2.2 )$$

The locations of points at which velocities and thermodynamic states were computed, shown in FIG. 3, are:
1 Entrance to impeller 302
2 Exit of Impeller-entrance to vaneless diffuser 304
2′ Exit of vaneless diffuser-entrance to vaned diffuser
3 Exit of vaned diffuser 306
4 Entrance to turbine stator 308
5 Exit from turbine stator-entrance to turbine rotor 310
6 Exit from turbine rotor 312

The following equations were used throughout the analysis for both the compressor and the turbine:

### Mass Flow Rate:

$${\dot{m}}_{compressor} = {ρ}_{1} {c}_{1} {A}_{1} = {\dot{m}}_{turbine} = {ρ}_{4} {c}_{4} {A}_{4} \qquad ( 2.21 )$$

Stagnation and Static Conditions were calculated using the following formulas:

$${H}_{0} = {c}_{P} ( T + \frac{{c}^{2}}{2} ) \qquad ( 2.22 )$$

$${P}_{0} = P ( {s}_{0} , {H}_{0} ) \qquad ( 2.23 )$$

$${T}_{0} = T ( {s}_{0} , {H}_{0} ) \qquad ( 2.24 )$$

where s₀ is the entropy at stagnation conditions.

No work in the diffuser of the compressor or the nozzle of the turbine:

$${T}_{02} = {T}_{03} and {T}_{04} = {T}_{05} \qquad ( 2.25 )$$

Euler's turbomachinery equation:

$${h}_{02} - {h}_{01} = {U}_{2} {c}_{θ2} - {U}_{1} {c}_{θ1} and {h}_{06} - {h}_{05} = U ( {c}_{θ6} - {c}_{θ5} ) \qquad ( 2.26 )$$

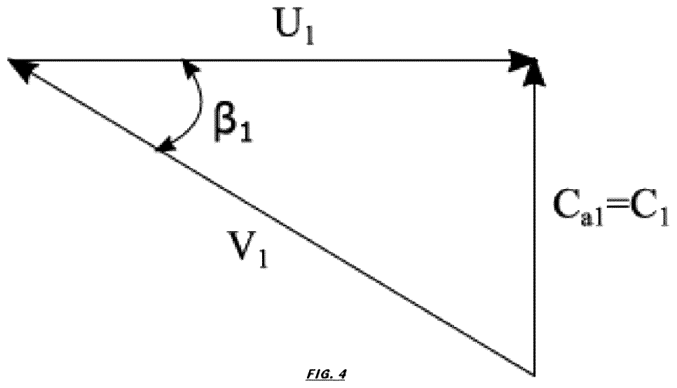

The first velocity triangle, depicted in FIG. 4, is calculated at the impeller inlet. According to this triangle, the relation between the velocity vectors is given by

$${V}_{1} = {C}_{1} - {U}_{1} \qquad ( 2.27 )$$

where V₁ and C₁ are the relative and absolute velocity of the air, respectively. The term U₁ denotes the impeller eye velocity vector or tangential velocity vector. It is assumed that the air enters the impeller eye in the axial direction, i.e., C₁=Cₐ₁.

At the impeller inlet (known also as eye or inducer), the effective diameter is defined according to

$${D}_{1} = \sqrt{0.5 ( {D}_{t}^{2} + {D}_{r}^{2} )} \qquad ( 2.28 )$$

where Dₜ is the diameter at the impeller eye tip and Dᵣ is the diameter at the impeller eye root. The annulus area of impeller eye is

$${A}_{1} = \frac{π}{4} ( {D}_{t}^{2} + {D}_{r}^{2} ) \qquad ( 2.29 )$$

The mean tangential speed at the inducer may be calculated by

$${U}_{1} = π {D}_{1} N \qquad ( 2.3 )$$

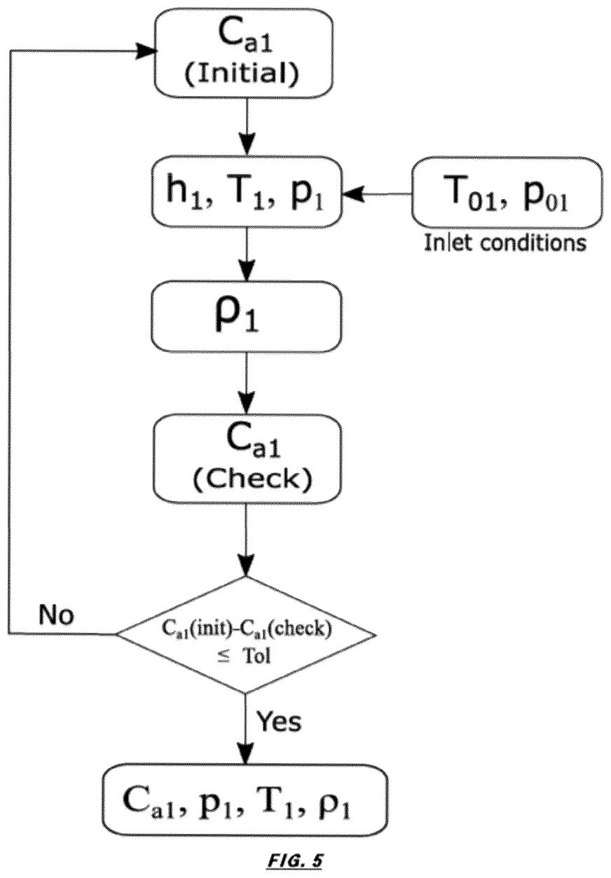

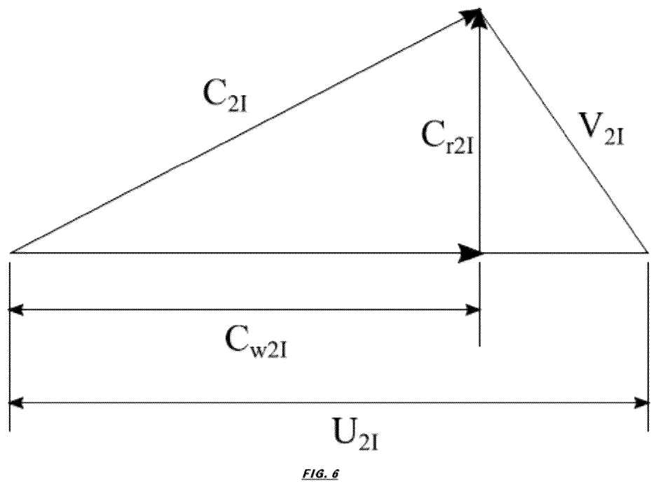

In addition, velocities at impeller eye tip Ut=πDtN and at impeller eye root Ur=πDrN may be found. It is important to check that the velocities at the impeller eye tip should be less than the speed of sound (Mt<1) to avoid breakdown of flow and excessive pressure loss. To calculate the axial component of the absolute velocity Cₐ₁, a trial and error process will be performed. FIG. 5 shows the iterative procedure followed to obtain the parameters at compressor inlet or station 1, according to this flow diagram, the density is calculated on the basis of the known stagnation temperature and pressure. From the continuity equation an initial estimate of the axial velocity Cₐ₁ is obtained. With this value and with the help of thermodynamic relations from the Mollier diagram, the density is recalculated, and the actual velocity is determined from the continuity equation. If the assumed and calculated velocities do not coincide, it is necessary to iterate until convergence is reached.

Equations required to calculate Cₐ₁, are presented. The static enthalpy h1 may be obtained by

$${h}_{1} = {h}_{01} - \frac{1}{2} {C}_{1}^{2} \qquad ( 2.31 )$$

where h01 is obtained from a polynomial function dependent on the temperature T01, i.e. h01=fh(T01). The static pressure p1 is given by

$${p}_{1} = \frac{{p}_{01}}{{e}^{\frac{{ϕ}_{01} - {ϕ}_{1}}{R}}} \qquad ( 2.32 )$$

Here, p01 is the total pressure. The terms ϕ01 and ϕ1 are functions dependent on the temperature T01 and T1, i.e. ϕ01=fϕ(T01) and ϕ1=fϕ(T1). The air density may be calculated from the equation of state for a perfect gas, thus

$${ρ}_{1} = \frac{{p}_{1}}{{RT}_{1}} \qquad ( 2.33 )$$

where R is the gas constant for the air and T1 may be found as a function of the enthalpy h1, i.e. T1=fh(h1). Finally, the axial velocity Cₐ₁ is given by

$${C}_{a 1} = \frac{{\dot{m}}_{a}}{{ρ}_{1} {A}_{1}} \qquad ( 2.34 )$$

Additional calculations are considered to obtain the relative velocity V1, V1=\sqrt{C₁²−U₁²} and the absolute Mach number, M_{1abs}=C₁/\sqrt{γRT}

The velocity triangle at the impeller tip is shown in FIG. 6. According to FIG. 6, the air leaves the impeller tip with an absolute velocity C2I. This velocity has a tangential or whirl component Cw2I and a small radial component Cr2I, they are related by

$${C}_{2 I} = \sqrt{{C}_{w 2 I}^{2} + {C}_{r 2 I}^{2}} \qquad ( 2.35 )$$

Under ideal conditions the whirl component will be equal to the impeller tip speed U2I. Due to the relative eddies in the impeller blade passage the impeller exit flow angle differs from the impeller exit blade angle; a measure of deviation can be calculated using the concept of a slip factor. There are many correlations predicting the slip factor. Von Backström describes a method that unifies the centrifugal impeller slip factor (σ). The prediction method of Dixon that uses one equation, will be used. This equation is given by

$$σ = 1 - \frac{1}{1 + {F}_{o} ( \frac{1}{{S}_{e}} ) {( cos β )}^{0.5}} \qquad ( 2.36 )$$

where Fo is a correction constant corresponding to the compressor. This value is adjusted to improve the accuracy of the prediction. The blade angle at impeller exit is denoted by B. The ratio given l/Se is known as the blade row solidity. The blade length l and blade spacing Se are determined with l=(re−ri)/cos β and Se=2πre/nb. The terms ri and re are the radius of the blade leading edge and blade trailing edge, respectively and the number of blades is denoted by nb. The area at impeller exit, A_{2I}, and the blade speed U_{2I} are calculated with A_{2I}=πD_{2I}b_{2I} and U_{2I}=πD_{2I}N respectively. The terms D_{2I} and b_{2I} are the impeller tip diameter and the axial width at impeller exit respectively. In terms of the slip factor and the blade tangential speed, the whirl component of the absolute velocity C_{w2I} are determined with

$${C}_{w 2 I} = σ {U}_{2 I} \qquad ( 2.37 )$$

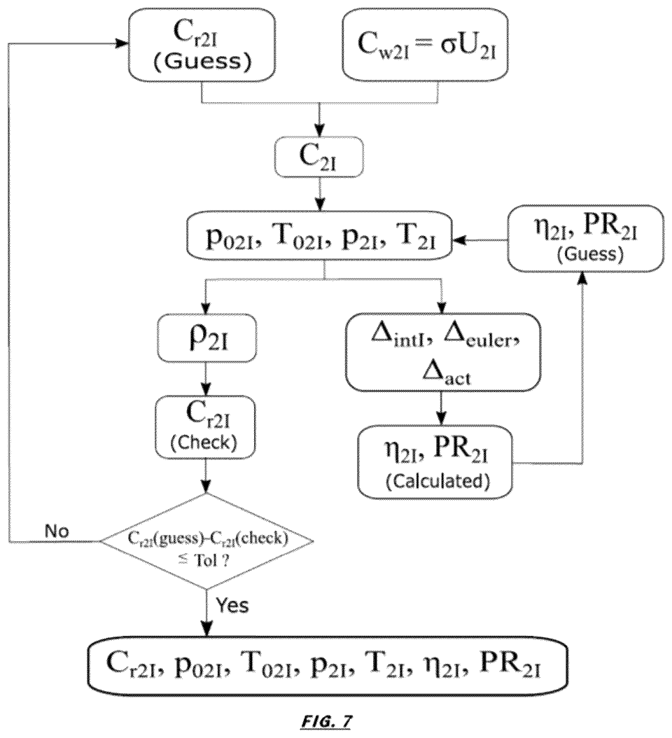

Some designers consider the value of the radial component C2I the same as the inlet axial velocity CaI (Cohen et al.) but, in the current model it is obtained with an estimated value based on equation (2.35). The final value of the radial component is determined following an iteration procedure which is shown in FIG. 7. According to the diagram shown in FIG. 7, static and stagnation pressures and temperatures have to be determined. Thus, the total pressure p02I is given by

$${p}_{02 I} = {p}_{01} {PR}_{2 I} \qquad ( 2.38 )$$

In equation 2.38, p01 is given as data and P R_{2I} is the pressure ratio. Initially P R_{2I} is guessed and then calculated. The stagnation temperature T_{02I} may be obtained from a correlation function of the stagnation enthalpy h_{02I}, i.e. T_{02I}=f_{T}(h_{02I}). The enthalpy h_{02I} is given by

$${h}_{20 I} = {h}_{01} + \frac{{h}_{02 Is} - {h}_{01}}{{η}_{2 I}} \qquad ( 2.39 )$$

where h₀₁ may be obtained from a correlation in function of the stagnation temperature T₀₁ which is given as data. The term η_{2I} denotes the efficiency that is initially guessed and finally calculated after some iterations. The stagnation enthalpy at an isentropic process h_{02Is} is obtained by the correlation function h_{02Is}=fh(T_{02Is}). In the same way, the temperature T_{02Is} may be given by the correlation function T_{02Is}=f_{T}(ϕ_{02Is}). The term ϕ_{02Is} is an entropy function obtained by the following expression

$${ϕ}_{02 Is} = {ϕ}_{01} + R ln ( \frac{{p}_{02 I}}{{p}_{01}} ) \qquad ( 2.4 )$$

where the entropy function ϕ₀₁ is obtained using the correlation function ϕ₀₁=f_{ϕ}(T₀₁). The static temperature T_{2I} is given in terms of the static enthalpy h_{2I} with the correlation function T_{2I}=f_{T}(h_{2I}). The enthalpy h_{2I} is calculated with the expression

$${h}_{2 I} = {h}_{02 I} - \frac{1}{2} {C}_{2 I}^{2} \qquad ( 2.41 )$$

The static pressure p_{2I} is given by

$${p}_{2 I} = \frac{{p}_{02 I}}{{e}^{\frac{{ϕ}_{02 I} - {ϕ}_{2 I}}{R}}} \qquad ( 2.42 )$$

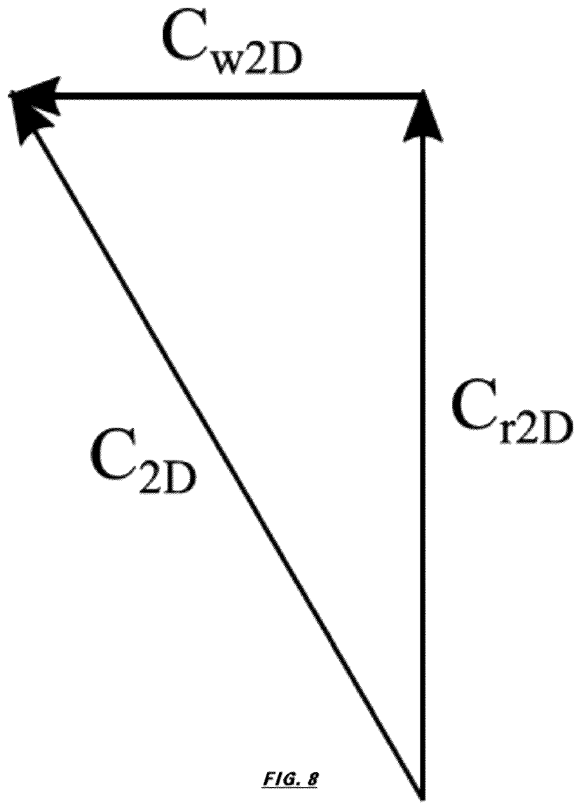

here the entropy functions ϕ_{02I} and ϕ_{2I} are given in terms of the temperatures T_{02I} and T_{2I} respectively, i.e. ϕ_{02I}=f_{ϕ}(T_{02I}) and ϕ_{2I}=f_{ϕ}(T_{2I}). The density and the radial component of absolute velocity are calculated using ρ_{2I}=p_{2I}/(RT_{2I}) and C_{r2I}=\dot{m}/(ρ_{2I}A_{2I}) respectively. The Mach numbers should be calculated to ensure that the flow does not exceed the velocity of sound. The performance parameters are also affected by losses that occur inside the compressor. The correlations used for the compressor losses were taken from Oh et al. and Jiang et al. The pressure ratio and isentropic efficiency may be given by

$${PR}_{2 I} = {[ ( \frac{Δ {h}_{euler} - \sum Δ {h}_{int}}{{c}_{p} {T}_{01}} ) + 1 ]}^{γ / ( γ - 1 )} \qquad ( 2.43 )$$

$${η}_{2 I} = \frac{Δ {h}_{euler} - \sum Δ {h}_{int}}{Δ {h}_{act}} \qquad ( 2.44 )$$

where, Δₕₑᵤₗₑᵣ is the ideal specific enthalpy change of the working fluid which depends on the slip factor and the tangential velocity of the blades at the impeller tip. Thus Δhₑᵤₗₑᵣ=σU_{2I}². The term ΣΔhᵢₙₜ represents the summation of all internal losses in the impeller such as incidence loss, blade loading loss, skin friction loss and clearance loss, thus ΣΔhᵢₙₜ=Δₕᵢ+Δh_{bld}+Δh_{sf}+Δh_{cl}. The actual specific enthalpy denoted by Δh_{act}, is the sum of the ideal specific enthalpy change and the parasitic loss correlations (Δh_{act}=Δhₑᵤₗₑᵣ+ΣΔhₚᵣₛ). The parasitic losses, ΣΔhₚᵣₛ, are assumed to be the sum of the disc friction loss, recirculation loss and the leakage loss, i.e. ΣΔhₚᵣₛ=Δh_{df}+Δh_{rc}+Δhₗₖ. The velocity triangle at the vaned diffuser inlet is depicted in FIG. 8.

In FIG. 8, only the absolute velocity C^{2D} and its components are present. The relative velocity vanishes because there is no moving element. To determine the whirl component C^{w2D} of C^{2D}, the conservation of the angular momentum within the vaneless diffuser can be assumed, i.e. C^{w2Dr2D}=C^{w2Ir2I}. Thus, the whirl component of the velocity is given by

$${C}_{w 2 D} = \frac{{C}_{w 2 I} {r}_{2 I}}{{r}_{2 D}} \qquad ( 2.45 )$$

The area and absolute velocity are obtained from A_{2D}=2πr_{2D}b_{2D} and c_{2D}=\sqrt{c_{r2D}²+c_{ω2D}²} respectively. The iterative procedure performed here is similar to that followed at the impeller exit. No further energy is supplied to the air after it leaves the impeller, so that neglecting the effect of friction, the angular momentum must be constant (Cohen et al.). The above implies that no work is done in the vaneless diffuser and the process is adiabatic. Thus, the following relation is obtained

$${h}_{02 I} = {h}_{02 D} \qquad ( 2.46 )$$

The pressure ratio and isentropic efficiency is calculated in the same way as in the last stage. Although here, Δh_{intI} is substituted by Δh_{intV D} which correspond to the losses in the impeller and the vaneless diffuser, as follows: Δh_{intV D}=Δh_{intI}+Δh_{vld}. Finally, calculations of the velocity triangle at the diffuser output are performed. Here, the whirl component of the velocity, is found using conservation of angular momentum, which yields C_{w2}=C_{w2D}r2_{D}/r₂. The area and the absolute velocity (magnitude) are A₂=2πr₂b₂ and C₂=\sqrt{Cₐ₂²+C_{w2}²} respectively. The iterative procedure to obtain the velocities and the thermodynamic states are similar to the previous stations. Assumptions done for the station of vaneless diffuser may be applied for the vaned diffuser, thus h_{02D}=h₀₂. In the calculations of the pressure ratio and the isentropic efficiency, the losses through the entire compressor stage (i.e., impeller, vaneless diffuser and vaned diffuser) have to be considered. These losses denoted by Δh_{intT} may be obtained by Δh_{intT}=Δh_{intV D}+Δh_{iD}+Δh_{sfD}, where Δh_{intV D} represents the internal losses in the impeller and vaneless diffuser, Δh_{iD} is the incidence loss in the diffuser, and Δh_{sfD} is the skin friction loss in the diffuser. The velocity triangles corresponding to the off-design performance are constructed taking into account the mass flow rate and rotational speed in the range of m=0-0.5 kg/s and N=50000-90000 rpm, respectively. In the off-design calculations it is assumed that the absolute inlet velocity remains axial and the design point value of the slip factor was constant for all off-design conditions.

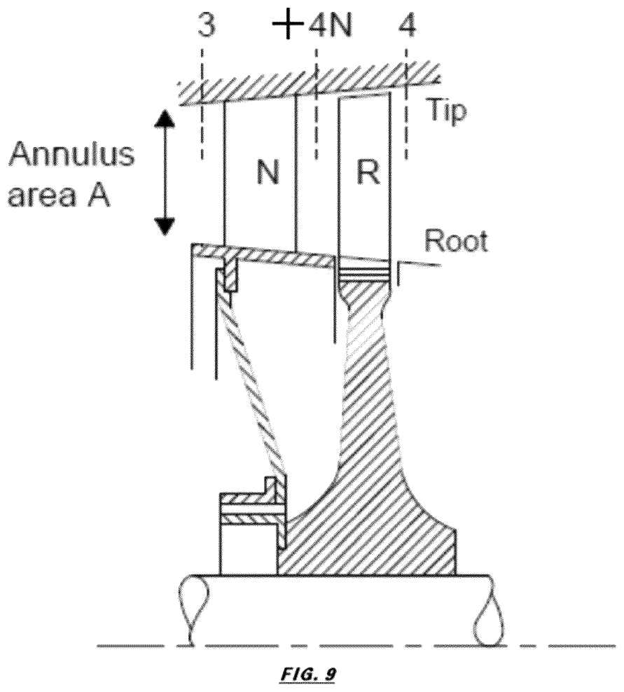

The SR-30 is a single stage axial turbine composed of one row of nozzles and one rotor. FIG. 9 shows the nomenclature of the stages employed in the calculations; N refers to the nozzle and R the rotor.

Ainley and Mathieson correlations were used to calculate the energy losses. These estimated losses will be useful in obtaining characteristic parameters such as the mass flow rate, \dot{m}, the rotational speed N, the pressure ratio P Rₜ and the efficiency ηₜ. The operating conditions used in establishing the design point velocity triangles were: \dot{m}=0.3 kg/s and N=78000 rpm. A mean annulus diameter is assumed in the calculations. This approach is valid when the ratio of the tip radius rₜ to the root radius rᵣ is low (rt/rr=1:38). The turbine considered in this work meets this low aspect ratio. Moreover, we can consider the mean diameter equal in all stations because the difference between the station mean diameters are negligible. Thus, the effective mean diameter may be given by Dₘ=\sqrt{0.5(Dᵣ²+Dₜ²)}. With the effective diameter and the rotational speed, the mean blade speed is U=πDₘN. The mean annulus area is calculated by Aₘ=π(Dᵣ²−Dₜ²)/4.

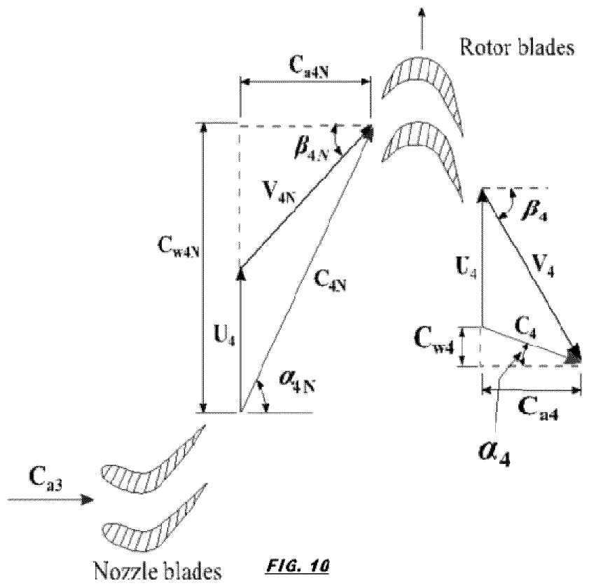

Geometric dimensions and inlet conditions were extracted from Witkowski et al. By using the geometric measurements of the turbine, a tip clearance of 0.54 mm was obtained. It is assumed that the stator blades have the same shape as the rotor blades. The fluid through the turbine is the air-fuel combustion products. FIG. 10 depicts the velocity configurations at each station in this turbine. In a single-stage turbine the velocity at turbine inlet C₃ will be axial (Cohen et al.), thus, C₃=Cₐ₃ (Cₐ₃ is the axial component of the velocity at turbine inlet or station 3). The value of this velocity will be taken as constant for all off-design conditions.

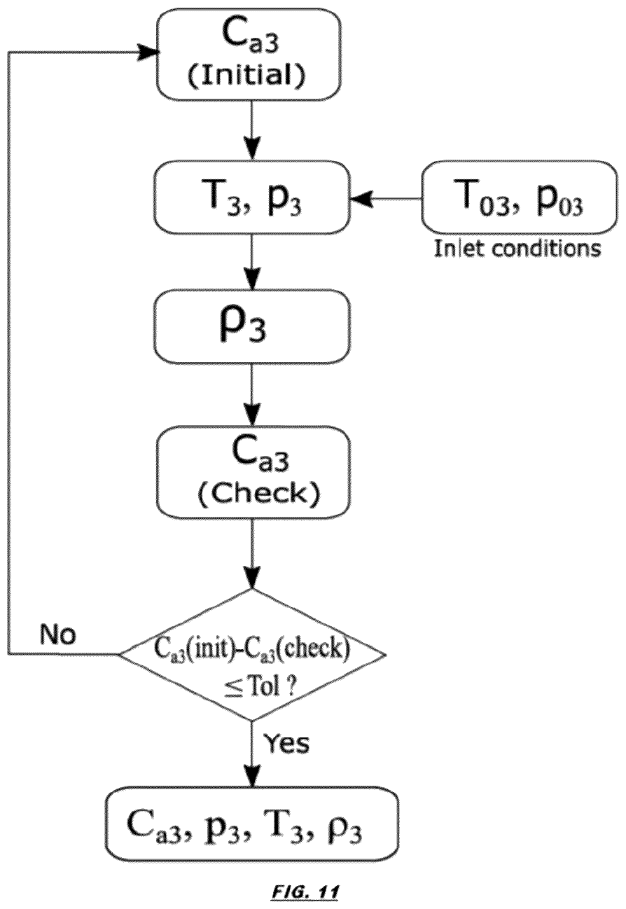

FIG. 11 shows the iterative procedure to calculate Cₐ₃. This procedure is similar to the calculations made at compressor inlet.

Initially, the velocity Cₐ₃ is guessed. Then, the static temperature is found using a correlation in terms of the static enthalpy h₃, i.e. T₃=f_{T}(h₃). The enthalpy h₃ is obtained by

$${h}_{3} = {h}_{03} - \frac{1}{2} {C}_{3}^{2} \qquad ( 2.47 )$$

where: h₀₃=fh(T₀₃, F AR) and F AR is the fuel-air ratio. The static pressure is obtained using

$${p}_{3} = \frac{{p}_{03}}{{e}^{\frac{{ϕ}_{03} - {ϕ}_{3}}{R}}} \qquad ( 2.48 )$$

where ϕ₀₃=f_{ϕ}(T₀₃) and ϕ₃=f_{ϕ}(T₃). Similarly to previous cases, the density is calculated with ρ₃=p₃/(RT₃). From the continuity equation, the axial velocity Cₐ₃ is calculated by. Cₐ₃=\dot{m}/(ρ₃Aₘ). Finally, the corresponding Mach number is determined using M_{3abs}=C₃/\sqrt{γRT₃}.

FIG. 10 shows the velocity triangle at the nozzle outlet or station 4N. It is assumed that the nozzle angle (α_{4N}) and the angular momentum at outlet remains constant. Therefore, for all off-design conditions the deviation of flow across the nozzle remains constant, thus α_{4N}=constant. As a result, the relationship between the whirl component C_{w4N} and the axial component C_{a4N} (notation shown in FIG. 10) will be constant according to the relation

FIG. 11 Flow diagram of the iterative procedure at the nozzle inlet

$${α}_{4 N} = {tan}^{- 1} ( \frac{{C}_{w 4 N}}{{C}_{a 4 N}} ) \qquad ( 2.49 )$$

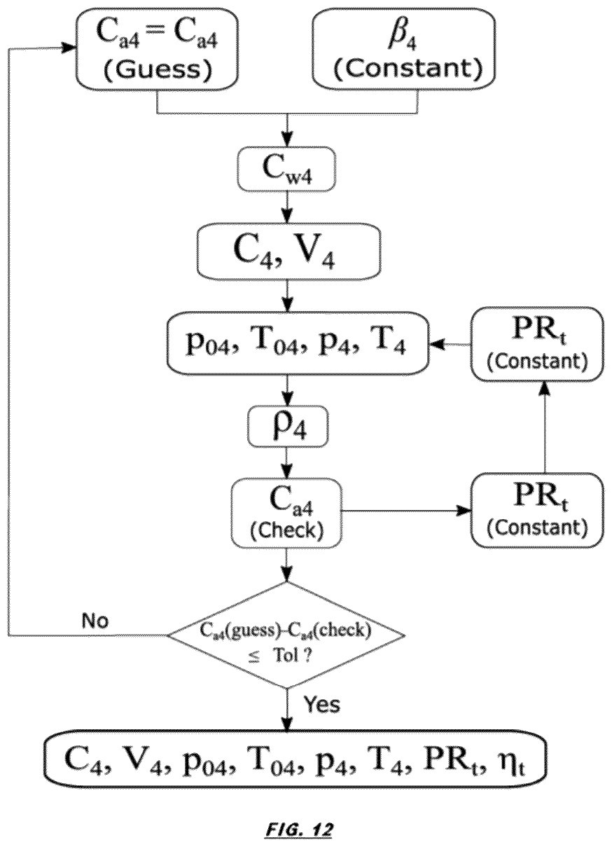

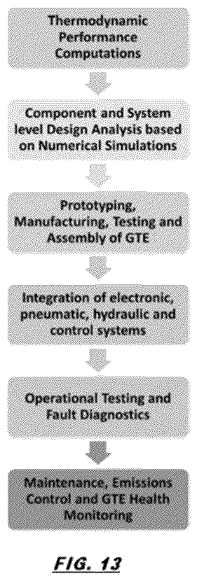

Since no work is done (adiabatic process) by the gas in the nozzle, the stagnation enthalpy must be constant over the annulus at the outlet. Thus, h_{04N}=h₀₃. FIG. 12 shows the flow chart used for the iterative procedure to obtain the axial component of the absolute velocity C_{a4N}.

The absolute velocity C_{a4N} is guessed. Using this value and the angle α_{4N}, the velocity component C_{w4N} is obtained (C_{w4N}=C_{a4N} tan α_{4N}). The absolute velocity C_{4N} is given by

$${C}_{4 N} = \sqrt{{C}_{a 4 N}^{2} + {C}_{w 4 N}^{2}} .$$

The static temperature T_{4N} is found in terms of the enthalpy, i.e. T_{4N}=f_{T}(h_{4N}). The static enthalpy h_{4N} is given by

$${h}_{4 N} = {h}_{04 N} - \frac{1}{2} {C}_{4 N}^{2} \qquad ( 2.5 )$$

The static pressure may be calculated by

$${p}_{4 N} = \frac{{p}_{03}}{{e}^{\frac{{ϕ}_{03} - {ϕ}_{4 Ns}}{R}}} \qquad ( 2.51 )$$

Where, ϕ₀₃=f_{ϕ}(T₀₃, F AR), ϕ_{4Ns}=f_{ϕ}(T_{4Ns}, F AR), and T_{4Ns}=f_{T}(h_{4Ns}, F AR). The enthalpy under isentropic process h_{4Ns} is found using

$${h}_{4 Ns} = {h}_{4 N} - {γ}_{N} \frac{{C}_{4 N}^{2}}{2} \qquad ( 2.52 )$$

where the total loss coefficient in the nozzle is denoted by γ_{N}. Neglecting the effect of friction, the critical pressure ratio is

$$\frac{{P}_{03}}{{P}_{c}} = {( \frac{γ + 1}{2} )}^{\frac{γ}{γ - 1}} \qquad ( 2.53 )$$

If P₀₃/P_{4N}<P₀₃/P_{c}, then the nozzle is not choked, otherwise, it is chocked. The density ρ_{4N} and the axial flow velocity C_{a4N} are as follow ρ_{4N}=p_{4N}/(RT_{4N}) and C_{a4N}=\dot{m}/(σ_{4N}Aₘ). The absolute velocity and relative flow angle are V_{4N}=

$$\sqrt{{( {C}_{w 4 n} - {U}_{4} )}^{2} + {C}_{a 4 n}^{2}} and {β}_{4 N} = {tan}^{- 1} [ ( {C}_{w 4 N} - {U}_{4} ) / {C}_{a 4 N} ] .$$

The velocity triangle at rotor outlet or station 4 is depicted in FIG. 10. The flow diagram of the iterative procedure at this station is presented in FIG. 12. According to the diagram in FIG. 12, the exit angle β4 is constant and it is calculated from the equations recommended by Ainley and Mathieson (Dixon), thus

FIG. 12 Flow diagram of the iterative procedure at the rotor outlet

$${β}_{4} = - 11.5 + 1.154 {cos}^{- 1} ( \frac{θ}{s} ) + \frac{4 s}{e} \qquad ( 2.54 )$$

In equation (2.54), θ is the throat width, s is the pitch and e is the mean radius of curvature of the blade suction surface. Equation (2.54) is for low outlet Mach numbers, i.e. 0<M₄<0.5. If M₄>1 the angle β₄ is calculated using β₄=cos⁻¹(θ/s). More details about this angle can be found in Dixon. Initially, the axial component of the absolute velocity Cₐ₄ is guessed using the equality Cₐ₄=C_{a4N}. The whirl component of the absolute velocity C_{w4} may be evaluated by

$${C}_{w 4} = {C}_{a 4} tan {β}_{4} - {U}_{4} \qquad ( 2.55 )$$

The absolute and relative velocity can be found similarly as in the other stations. The static temperature is found by the correlation T₄=f_{T}(h₄, F AR). The static enthalpy h₄ is given by

$${h}_{4} = {h}_{04} - \frac{{C}_{4}^{2}}{2} \qquad ( 2.56 )$$

where h₀₄ is calculated by

$${h}_{04} = {h}_{03} - {UC}_{a 4 N} ( \frac{2 U}{{C}_{a 4 N}} + tab {β}_{4 N} - \frac{{C}_{a 4}}{{C}_{a 4 N}} tab {β}_{4} ) \qquad ( 2.57 )$$

In equation (2.57), the stagnation enthalpy hos is obtained by h₀₃=fₕ(T₀₃, F AR). Using the stagnation enthalpy h₀₄, the stagnation temperature is computed with T₀₄=f_{T}(T₀₄, F AR). The stagnation pressure is found from

$${p}_{04} = \frac{{p}_{03}}{{PR}_{t}} \qquad ( 2.58 )$$

where P Rₜ is the total pressure ratio which is guessed initially and then calculated by P Rₜ=(ϕ₀₃−ϕ₀₄ₛₛ)/R. The entropy function ϕ₀₃ is obtained using ϕ₀₃=f_{ϕ}(T₀₃, F AR). The stagnation entropy function ϕ₀₄ₛₛ is given by ϕ₀₄ₛₛ=ϕ₄ₛₛ+R ln(p₀₄/p₄). The static entropy function ϕ₄ₛₛ is obtained from the correlation ϕ₄ₛₛ=f_{ϕ}(T₄ₛₛ, F AR) where the static temperature T₄ₛₛ is calculated using the correlation T₄ₛₛ=f_{T}(h₄ₛₛ, F AR). The static enthalpy h₄ₛₛ is given by h₄ₛₛ=h₄ₛ−(T₄/T_{4N})(h_{4N}−h_{4Ns}). The static isentropic enthalpy h₄ₛ is found using

$${h}_{4 s} = {h}_{4} - {γ}_{R} \frac{{V}_{4}^{2}}{2} \qquad ( 2.59 )$$

where γ_{R} is the total loss coefficient in the turbine rotor. The static pressure p₄ was calculated with

$${p}_{4} = \frac{{p}_{04}}{{e}^{\frac{{ϕ}_{04} - {ϕ}_{4}}{R}}} \qquad ( 2.6 )$$

here ϕ₀₄=f_{ϕ}(T₀₄, F AR) and ϕ₄=f_{ϕ}(T₄, F AR). The isentropic efficiency is determined using

$${η}_{t} = \frac{{h}_{03} - {h}_{04}}{{h}_{03} - {h}_{04 ss}} \qquad ( 2.61 )$$

The density and the axial velocity component are calculated using equations similar to the previous cases. In addition, the mach number M4 may be found by M₄=V₄/\sqrt{γRT}. After doing the design point performance analysis, the off-design performance is obtained varying the speed and the mass flow rate. The speed was varied from 50000 rpm to 90000 rpm and the mass flow rate was varied until the design value was reached (0.3 kg/s). The deviation of flow across the nozzle is assumed as constant at all off-design conditions. Because α_{4N} is constant the losses across the nozzle remain constant for all off-design conditions.

Gas Turbine Engine (GTEs) have been predominantly used for power generation and aircraft propulsion. An Increase in GTE efficiency of even 1% can lead to lowering the carbon footprint per unit of electricity generated while saving over $50 million in fuel cost-savings over a ten-year period in the US, and thus, keeping the maintenance and capital costs lower. Combining experimental, and analytical approaches to increase the operational efficiency of the small scale GTE SR-30 through machine learning models will play a critical role in predicting the off-design and transient behavior of the engine with uncertainty quantification. The SR-30 GTE's operational envelope between rotational speed of 45,000 to 80,0000 (RPM) was studied by conducting experiments using various fuels such as Jet-A and Kerosene. Their performance parameters such as component efficiencies of compressor, and turbine will be examined through thermodynamic computations and the data obtained will assist in understanding the non-linear nature of the performance efficiencies. A data-driven physics-based high-fidelity machine learning model is developed to predict the component level and overall efficiency for the SR-30 GTE. Various models from Polynomial regression, ridge regression, robust regression, Support Vector Machine, Random Forest Regressor, Stochastic Gradient, XGBoost, Gaussian Process Regression and Artificial Neural Network (ANN) are used to optimize the highest efficiency over the operational envelope. The hyper-parameters in the Machine Learning models are optimized and their performance in the prediction of the Compressor and Turbine efficiency is conducted based on the statistical scoring metrics. A user-friendly Graphical User Interface is created to serve as a tool to predict the performance efficiency of the GTE turbomachines.

Improving the efficiency of Gas Turbine Engines, which are primarily used for generating electricity and powering aircraft, by just 1% can significantly reduce the carbon footprint from electricity production. In the United States, such an enhancement could also result in fuel cost savings of over $1 billion over ten years, while concurrently lowering maintenance and capital costs. Gas turbine engines are known for their high thrust-to-weight ratio, which allows aircraft to achieve high speeds and altitudes. The Engine Development and Monitoring Lifecycle (EDML) consists of 6 stages: 1. Thermodynamic Performance calculations to determine efficiencies of GTE through effective design of the components such as compressors, turbines etc.; 2. Numerical Analysis and Optimization of component and system level performance; 3. Manufacturing processes and assembly of the components; prototyping and; 4. integration of the electrical, control, and mechanical systems; 5. Testing and fault diagnostics to ensure the design, structural, and thermal performance; 6. Maintenance, emissions control, and engine health monitoring. GTE's are also relatively efficient in terms of power-to-weight ratio but require a complex design and maintenance and are more susceptible to damage due to overheating or foreign object ingestion. This lack of design and performance optimization using machine learning leads to inefficient operation of GTE.

Small scale gas turbine engines are known for their high power-to-weight ratio, high thermal efficiencies, and low emissions. However, the performance of small scale gas turbine engines can be affected by several factors, such as the compression ratio, turbine temperature, and the use of advanced materials and cooling systems. Techniques such as exergy analysis are used to evaluate the thermal efficiency of the system and identify sources of inefficiency, which can help to identify areas for improvement and optimize the performance of the engine. Yucer presents a thermodynamic analysis of the part-load performance of a small scale gas turbine jet engine using energy analysis method. Yucer's study describes the thermodynamic analysis of the performance of the engine at different part-load conditions by using the first and second laws of thermodynamics, and it also uses the exergy efficiency as a measure of performance. The results show that the exergy efficiency is higher than the energy efficiency and the exergy destruction is highest in the combustion chamber. This disclosure has found that exergy analysis method is a powerful tool to evaluate the performance of small-scale gas turbine jet engines, and it also highlights the potential of this method to optimize the performance of these systems and reduce the energy losses in the combustion chamber. Singh et al. details a comprehensive study of the Mini SR-30 gas turbine engine, involving mathematical modeling, simulation, and empirical validation. The process includes developing a detailed model of the engine, simulating its performance under various conditions, and validating these simulations with real-world testing data. This approach offers significant insights into the engine's operational characteristics, benefiting both theoretical understanding and practical engineering applications.

In terms of gas turbine engine control, Surendran et al. explore the application of multi-parametric Model Predictive Control (mp-MPC) strategies on a laboratory SR-30 gas turbine, aiming to regulate the engine speed and turbine exhaust pressure. The strategy begins with developing an empirical transfer function model based on experimental data, linking fuel flow, shaft speed, nozzle diameter, and turbine exhaust pressure. Although initial MPC results showed satisfactory output responses, they had high computational demands. To improve efficiency, the inventors implemented multi-parametric MPC controllers, integrating operational constraints into the design. The results demonstrate that the multi-parametric MPC approach significantly reduces computational time while maintaining effective control over the gas turbine's performance, making it a more efficient alternative to conventional MPC methods.

As sustainability comes to the forefront in GTE operations for aircraft propulsion Mendez et al. present a study on the performance and emission characteristics of a small scale gas turbine engine fueled with ethanol/Jet A blends. The inventors conduct experiments to evaluate the engine's performance and emissions when running on different blends of ethanol and Jet A fuel. They compare the results to the performance and emissions of the engine running on Jet A fuel alone. The results show that the engine's performance and emissions are affected by the blend of fuel used, with the engine's performance decreasing and emissions increasing as the proportion of ethanol in the blend increases. The paper concludes that blending ethanol with Jet A fuel can have a negative impact on the performance and emissions of small scale gas turbine engines and more research is needed to develop methods to mitigate these effects.

In order to study the emissions from the GTE operation, Badami et al. conducted a study on the performance of a small scale turbojet engine using traditional and alternative fuels. The authors conduct experiments to evaluate the engine's performance when running on different fuels such as Jet A-1, kerosene, diesel, and biofuels. They compare the results to the performance of the engine running on Jet A-1 fuel. The results show that the engine's performance is affected by the fuel used, with the engine performing better on Jet A-1 than on the alternative fuels. The paper concludes that alternative fuels may not be suitable for use in small scale turbojet engines due to their lower performance compared to Jet A-1 fuel. They also present a study on a small scale turbojet engine, which includes both experimental and numerical analysis. The authors conduct experiments to collect data on the engine's performance and use numerical simulations to model the engine's behavior. They compare the results of the experiments and simulations to identify any discrepancies and to gain insight into the engine's performance. They also present the results of the engine's performance and emissions. The paper concludes that the experimental and numerical methods provide a better understanding of the engine's behavior, which can be used to improve the engine's performance and reduce emissions.

To leverage the usage of machine learning and performance prediction tools, Zhou et al. present a study on using an extreme learning machine (ELM) to model the performance of a small scale turbojet engine. The authors propose a robust ELM algorithm that can handle noise and outliers in the data. They evaluate the performance of the algorithm on a dataset of engine performance data and compare it to traditional modeling methods such as linear regression and support vector regression.

The results show that the ELM algorithm is able to achieve better performance and higher robustness than the traditional methods. The paper concludes that the robust ELM algorithm is a promising approach for modeling the performance of small scale turbojet engines. They also present a study on using an extreme learning machine (ELM) algorithm based on C-loss function to estimate the power of small scale turbojet engines. The authors propose a C-loss based ELM algorithm which is a variation of the traditional ELM algorithm that uses a C-loss function for the training process. They evaluate the performance of the algorithm on a dataset of engine performance data and compare it to traditional ELM algorithm and other machine learning algorithms such as support vector regression, and linear regression. The results show that the C-loss based ELM algorithm is able to achieve better performance and higher robustness than the traditional ELM and other machine learning algorithms. The paper concludes that the C-loss based ELM algorithm is a promising approach for estimating the power of small scale turbojet engines. Watanabe et al. explores the use of soft computing techniques, like fuzzy logic and neural networks, to enhance the operation of the SR-30 turbojet engine. These methods, adept at handling data uncertainty, are applied for tasks like fault detection and optimization. The study aims to demonstrate improvements in the engine's efficiency, fault tolerance, and overall performance, highlighting the potential of soft computing in aerospace engineering.

In the EDML, it is vital to emphasize Stage 6—maintenance and reliability for proper continued operation of GTE. Hence, Zhong et al. describe a method for diagnosing faults in gas turbines using transfer learning with convolutional neural networks (CNNs). The authors propose a novel approach that utilizes a pre-trained CNN model and fine-tunes it with a small amount of labeled data to improve its performance for the specific task of gas turbine fault diagnosis. The method is evaluated using a publicly available dataset and is shown to achieve better performance compared to traditional methods. In another study, Nott et al. explore the use of AI techniques to detect sensor failures in turbojet engines, employing a combination of neural networks, statistical methods, and Bayesian belief networks for accurate diagnostics. By using the SR-30 engine as a test case, the study initially uses neural networks to identify sensor issues marked by increased noise, then applies Bayesian statistics to pinpoint sensor bias. A BBN framework integrates these methods to determine whether sensor failures are indicative of broader engine issues or are independent occurrences. The developed system is adept at distinguishing between sensor error types across different engine operations, proving its efficacy in the dynamic environment of turbojet engines.

With higher dimensional data present in the experimental studies for GTEs, Xie et al. wrote a review of feature selection and feature learning techniques in machine learning applications for gas turbine systems to reinforce the importance of influencing parameters on the performance prediction. The authors provide an overview of the most common methods used for feature selection, including filter methods, wrapper methods, and embedded methods, and also discuss the use of feature learning techniques such as deep learning and transfer learning. They also present a summary of recent research in gas turbine systems and the corresponding feature selection and feature learning techniques applied in this field. The paper concludes that feature selection and feature learning are crucial steps in the development of machine learning models for gas turbine systems, and that there is a growing trend towards the use of deep learning and transfer learning techniques].

In this disclosure, we investigate the use of machine learning techniques to predict and optimize the component level and overall performance of the small scale gas turbine SR-30 and develop a user-friendly graphical user interface (GUI) for monitoring the operational efficiency in real-time.

### Experimental Methodology

The SR-30 GTE engine has been used as an instructional tool in various institutions and universities. Callinan and Hikiss describe the practical experience of using this system at the Loyola Marymount University's Mechanical Engineering Department where it offers students a hands-on opportunity to apply thermodynamic principles and provides valuable insights into the performance of turbojet engines. Leonard et al. discuss a decade long educational initiative involving the utilization of this engine as an instructional tool covering its evolution, modifications, and integration as a practical aid in teaching, enhancing theoretical understanding and practical skills related to jet engine operation and analysis. Pourmovahed et al. introduced a jet engine experiment to enhance its educational offerings in the Energy Systems Laboratory at Kettering University. Similarly, Witkowski et al. describe how they teach students to characterize the performance of this engine systematically as a part of the senior lab for mechanical engineering students at the university of Minnesota. These educational experiments focused on understanding engine thrust, component efficiency, and combustion processes, aided by data collection at various speeds. The following section describes the methodology used in the experiments on the SR30 gas turbine engine, focusing on data collection while utilizing Kerosene and Jet A fuels to gather operational parameters.

### Experimental Set-Up

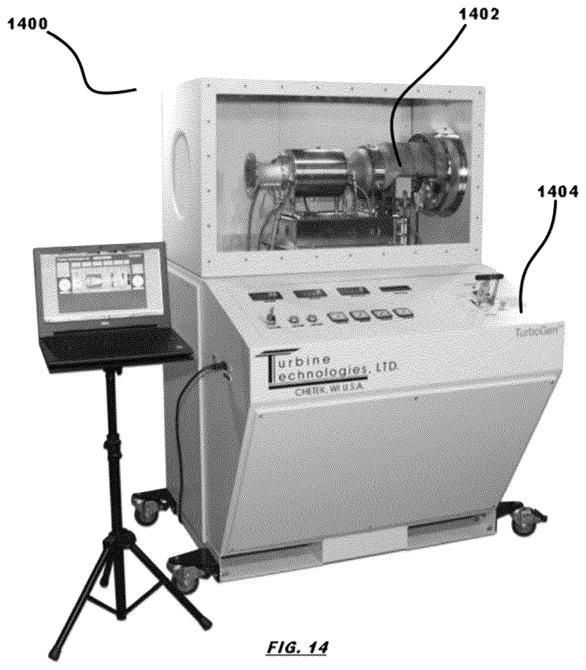

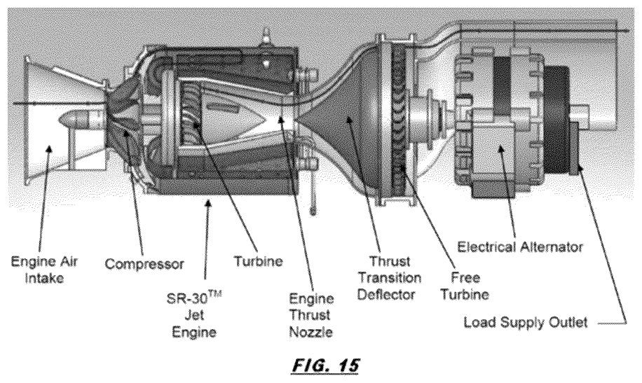

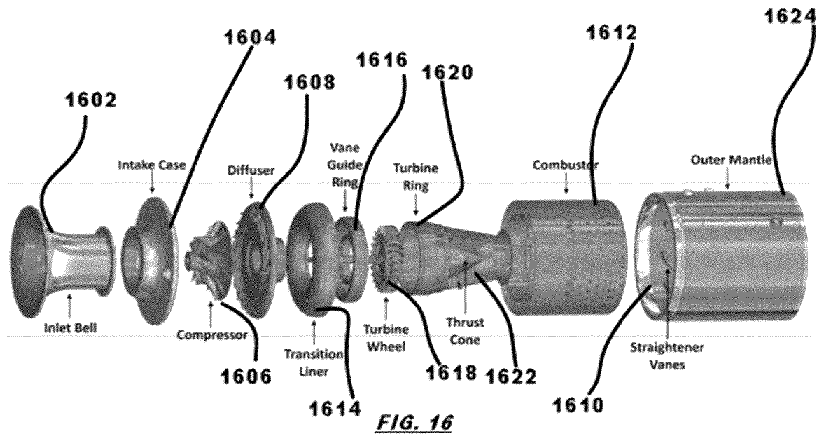

The TurboGen Gas Turbine, manufactured by Turbine Technologies Ltd, is an Electrical Generation System used to conduct experiments which encompasses the SR-30 jet engine and TG-2000 electric generator. The SR-30 Gas Turbine Engine consists of an inlet, centrifugal compressor, reverse-flow annular combustion chamber, axial turbine and converging exhaust section. TG-2000 electric generator is driven by a free turbine which is a second stage axial turbine wheel that is not connected to SR-30 by shaft rather turned by the thrust force. Temperature, pressure, and RPM data are collected from 15 sensors along the stream-wise length of the SR-30 and TG-2000, and reported to the NI-DAQ system. This system is integrated with a LABVIEW user interface for real-time data visualization, and post-processing and analysis. The data obtained from these experiments are instrumental in the creation of machine learning models to predict efficiencies and serve as a benchmark for design optimization for the SR-30 GTE. FIG. 14 illustrates the setup for the TurboGen experiment, while FIG. 15 depicts the SR-30 GTE and TG-2000 electrical generator components, respectively.

### SR-30 Gas Turbine Engine Operation

The inlet serves as the initial component of the gas turbine engine, responsible for encountering the essential gaseous working fluid (atmospheric air) and not subjected to extreme temperatures for proper GTE's operation. The centrifugal compressor, also known as an impeller, with operational envelope between 45,000 and 80,000 revolutions per minute (RPM), takes inlet air at the impeller hub and centrifugally accelerates it in a radial direction toward the outer circumference of the impeller and discharges through the diffuser. Within the diffuser of the SR-30 engine, the air undergoes change from radial flow to an axial flow process, resulting in an increase in static pressure. This leads to a maximum pressure ratio of 3 for the SR-30 engine.

The high-pressure air from the diffuser enters the reverse flow annular combustor with the two concentric perforated tubes. The self-sustaining combustion takes place once the fuel-air mixture is ignited within the temperature range of 400-800 degree Celsius controlled by the secondary bleed air. The hot combustion gases flow through the vane guide ring-stator, which consists of shrouded series of small airfoil blades which directs this accelerating gas to the axial flow turbine to convert energy to mechanical work. The thrust nozzle, designed as a convergent tube with a gradually decreasing cross-section, facilitates the conversion of the remaining heat energy from combustion into kinetic energy. The exhaust gas then enters the diverging cone to drive the free turbine which spins a Liquid-Cooled Alternator to generate electricity.

Comprehensive pre-start procedures should be conducted by the personnel, which are fundamental in confirming the operational readiness and safety of the system and personnel. The key elements of the pre-start procedures are the mandatory use of Personal Protective Equipment (PPE) and fire safety measures such as fire extinguishers, along with ensuring the system stability through locked caster wheels and the positioning of the keyed master switch to the off state, thereby establishing a safe baseline for operation. The fuel and oil quantities must be checked and ensured for adequate volume and a final visual inspection must be conducted before the experiment is begun.

Once the Keyed Master Switch is turned ON, sequential verification of critical system components such as turbine inlet temperature, engine and generator RPMs, and throttle operation is necessary. This ensures a thorough check of the system's functionality prior to engine ignition. The throttle and the load lever are verified for full range of motion before the OneTouch AutoStart System is turned on. The OneTouch System plays a crucial role in monitoring and executing the start sequence, ensuring a safe and efficient start-up. In case of any issues at the startup, various procedures for air clearing, hung start, oil/fuel pressure issues, etc., troubleshooting procedures are followed.

To start the operation of the GTE, the prestart and starting procedure is conducted as per the specified operational guidelines from Turbine Technologies, and Turbine Inlet Temperature and Air pressure is monitored continuously. The GTE operation with Kerosene and Jet A fuels is conducted with the operation RPM between 40000-80000, in increments of 5000, and waiting 5 minutes between each set value to reach steady state operation. During the shutdown procedure, the idle RPM is reached and air clearing procedure is used to cool the system down. FIG. 16 highlights the parts of the SR-30 GTE highlighting the complexity in the design of GTE and the importance of design considerations.

### Components of SR-30 Gas Turbine Engine

The experimental setup at Midlands Technical College is a TurboGen Gas Turbine

Electrical Generation System 1400 with a self-contained jet engine 1402 and electrical generator 1404 featuring the SR-30 Jet Engine and TG-2000 Electric Generator. The SR-30 is a single-spool straight turbojet engine with radial compressor, diffuser, reverse-flow annular combustion chamber, and axial turbine. The exhaust gas from the SR-30 operates a free axial turbine which in turn is connected to the liquid-cooled alternator to generate power. The components of the SR-30 GTE and TG-2000 electrical generator are displayed in FIG. 16 and are elaborated below.

### Inlet Bell 1602

The inlet bell in a gas turbine engine is an essential element engineered to efficiently channel atmospheric air into the engine. It represents the initial stage of the engine's air intake system and is pivotal in guaranteeing the optimal flow of air into the engine. The engine inlet's role is to finalize the conditioning of the inlet air before it enters the engine's interior. The SR-30™'s inlet exemplifies a common subsonic inlet duct, where ambient air is directed straight to the compressor's face. This inlet design conforms to an ASME-established standard known as the “ASME Long Mouth Inlet Bell.

### Intake Case 1604

The compressor cover, also known as the intake case 1604 in a gas turbine engine, is designed to mirror the contours of the centrifugal compressor blades. This design ensures optimal clearance, reducing pressure loss while providing ample room for the compressor to rotate. It is crucial in encasing the early stages of the compressor, streamlining airflow management, providing essential structural support, and lessening aerodynamic disruptions.

### Compressor 1606

The compressor 1606, or rotor, combined with the compressor turbine, forms the turbojet engine's rotating assembly. In the SR-30™ engine, a centrifugal (radial flow) compressor is used, with its flow path oriented relative to the compressor's rotational axis. When viewed from the inlet bell, the compressor operates in a counter-clockwise direction, a necessary orientation for its proper functioning. This rotation imparts energy to the incoming air. The compressor, also referred to as an impeller, can reach speeds up to 85,000 revolutions per minute. At these high speeds, air entering at the impeller hub is accelerated centrifugally outwards towards the impeller's outer edge, from where it exits through the diffuser 1608. The design of the compressor blades, along with the aerodynamic and fluid forces generated by this rotation, induces a beneficial alteration in the working fluid's velocity and pressure.

### Diffuser 1608

The diffuser 1608, also known as the stator, operates in tandem with the compressor 1606 to continue processing the working fluid. Air exiting the compressor is channeled through the diffuser 1608, where its velocity is reduced while its static pressure is heightened. This discharge air also experiences a directional shift of 90 degrees, transitioning from radial to axial flow. Together, the compressor and diffuser form the compressor stage of the engine.

### Straightener Vanes 1610

The straightener vanes 1610 play a pivotal role in refining the airflow exiting the diffuser 1608 by effectively removing any remaining whirl component from the air discharged by the diffuser. These vanes are precisely engineered to interact with the airflow post diffusion, which often still carries a degree of rotational motion or angular momentum. By meticulously aligning and reorienting this air, the straightener vanes ensure that it flows more linearly and axially, in alignment with the engine's central axis. This correction is crucial for optimizing the air's entry into subsequent stages of the engine, such as the combustion chamber, where uniform, stable airflow is necessary for efficient combustion and energy conversion. The presence and functionality of the straightener vanes, therefore, are not just about directing airflow, but also about enhancing the overall aerodynamic efficiency of the gas turbine engine, ensuring that the air is in its most effective state for the engine's next operational phase.

### Combustor 1612

The high-pressure air exiting the diffuser 1608 is channeled into the combustion chamber, or combustor 1612, of the engine. Here, in the case of the SR-30™ engine, an annular type combustor, comprising two perforated tubes arranged concentrically, plays a crucial role. Its primary function is to elevate the pressure and potential energy of the working fluid by burning a mixture of gaseous fuel and air. Interestingly, the combustor is designed in a reverse flow setup, with its inlet positioned at the engine's rear. Only a minimal portion of the air from the compressor is required for combustion. This air, mixed with fuel at the combustor's inlet, is initially ignited by a high voltage spark type igniter plug during engine start. Post ignition, the combustion becomes self-sustaining, negating the need for continuous sparking. Additional air, known as secondary air, enters through larger holes in the combustor 1612. This air plays a dual role in both stabilizing and positioning the combustion flame within the combustor 1612 and cooling the combustion gases to temperatures suitable for the engine's operation, often determined by the limits of the component materials. The annular design of the combustor enhances its volumetric efficiency and ensures a nearly uniform pressure distribution around its internal circumference.

### Transition Liner 1614

Exiting the annular combustor 1612, the hot combustion gases encounter the transition liner 1614, a crucial component that redirects them by 180 degrees. Initially, as these gases leave the combustor 1612, they move in a reverse direction, opposite to the engine's typical airflow. The transition liner's 1614 primary role is to reorient this flow, guiding the hot gases back to the normal front-to-back direction of the engine. This redirection is vital for aligning the gases for their next stage of passage through the engine, ensuring a smooth flow into the turbine section. The liner not only facilitates this directional shift but also plays a part in managing the temperature and flow characteristics of the gases, preparing them for efficient energy extraction in the turbine stages that follow. This process showcases the intricate design and functionality within the gas turbine engine, where each component is strategically positioned to optimize the flow and conversion of energy throughout the system.

### Vane Guide Ring 1616

Located at the beginning of the turbine stage, the vane guide ring 1616, also known as the stator, is essential for the turbine's extraction of useful work from the combustion process. This ring features a shrouded array of small airfoil blades, each angled to intercept the flow of combustion gases channeled by the transition liner 1614. The spacing between these blades causes the path of the hot, high-pressure combustion gases to constrict, resulting in their acceleration into a fast-moving, high-energy stream. Crucially, the vane guide ring 1616 is designed to channel this rapidly moving gas flow so that it interacts most effectively with the turbine blades. This precise direction of the gas flow is key to maximizing the turbine's ability to convert the energy from the combustion gases into mechanical work efficiently.

### Turbine Wheel 1618

The turbine wheel 1618, or rotor, plays a crucial role in the gas turbine engine by absorbing energy from the accelerating gas flow and transforming it into mechanical power. As the expanding flow passes through the turbine blades, it undergoes further acceleration. These blades, shaped similarly to airfoils just like those in the vane guide ring, leverage a combination of aerodynamic forces and reaction principles to induce rotation. The turbine is intimately linked with the compressor; its primary function is to drive the compressor, thus sustaining the engine's continuous flow cycle. The power extracted by the turbine is precisely calibrated to meet the compressor's operational needs, with any excess energy being channeled towards generating propulsive thrust. This efficient utilization of energy underscores the turbine's vital role in balancing the engine's internal power requirements with the external demands of propulsion.

### Turbine Ring 1620

The turbine ring 1620, also known as the containment housing, fulfills a dual role in a gas turbine engine. Firstly, it acts as a radial structural barrier, offering containment in the rare event of a turbine blade failure. This ensures safety by preventing fragments from escaping the engine. Secondly, it plays a crucial role in managing the gas flow, providing a controlled environment for the proper expansion of gases through the axial flow turbine. This containment is essential for maintaining the efficiency and effectiveness of the gas flow path within the turbine.

### Thrust Cone 1622

The thrust cone 1622, designed as a converging tube with a progressively decreasing cross-sectional area, plays a pivotal role in transforming the residual heat energy from combustion into kinetic energy. As the gases pass through this nozzle, they are accelerated to high velocities, culminating in the generation of propulsive thrust at the nozzle's exit.

### Outer Mantle 1624

The outer mantle 1624, being the outer most sheet metal casing, serves as a structural foundation for flange rings that bolster the compressor assembly. Additionally, it acts as an anchoring point for attaching the fuel nozzle assembly, playing a critical role in the overall structural integrity and functional assembly of the engine.

### SR-30 Gas Turbine Engine Data Collection

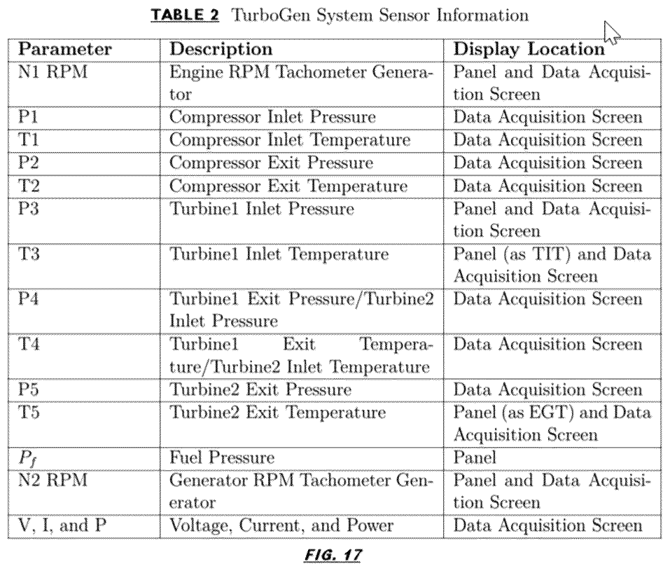

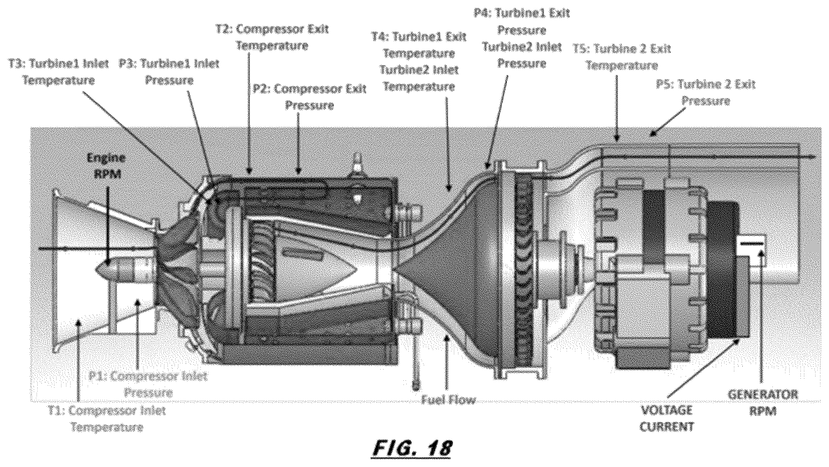

The TurboGen software in conjugation with the NI-DAQ (National Instruments-Data AcQuisition) is used for the data collection of the operational parameters. In the operational range, various pressure and temperature measurements are conducted at specific locations within the engine. They include pressures and temperatures at Compressor Inlet (P1, T1), Compressor Exit/Combustor Inlet (P2, T2), Combustor Exit/Turbine Inlet (P3, T3), Turbine Exit/Free Turbine Inlet (P4, T4), and Free Turbine Exit (P5, T5). The TurboGen Digital Data Acquisition System utilizes a National Instruments 6218 USB Data Acquisition Module. The unit features a 22-bit analog to digital conversion capability for multiple voltage channels, thermocouples, pulse, frequency and digital I/O to be measured and controlled. The USB's high-speed data transfer rate (up to 250 Ks/s) allows for a real-time display of acquired data, while eliminating the need for buffer memory in the data acquisition system itself. TABLE 2, see FIG. 17, provides a detailed overview of all 15-sensor data obtained for further analyses.

### Analysis of Operational Data for SR-30 Gas Turbine Engine

The experimental data such as temperature, pressure, RPM obtained from the 15 sensors is evaluated used thermodynamic principles. The thermodynamic equations are then used to compute the component and overall efficiencies of the SR-30 GTE based on the analytical solutions for engine performance. The data from the experiments is used in the development of the data-driven physics-based modeling to predict the performance of SR-30 GTE which can be extrapolated to similar single shaft GTE's. The control volumes such as that of centrifugal compressor, annular reverse flow combustion chamber combustor, axial turbine are chosen and perfect gas, incompressible assumptions are made and the equations of mass and energy conservation and an entropy balance are used to compute the stage-wise and component level performance.

$$\sum {\dot{m}}_{in} = \sum {\dot{m}}_{out} \qquad ( 3.1 )$$

$$\dot{Q} - \dot{W} = \sum {\dot{m}}_{out} [ {h}_{out} + \frac{{V}_{out}^{2}}{2} ] - \sum {\dot{m}}_{in} [ {h}_{in} + \frac{{V}_{in}^{2}}{2} ] \qquad ( 3.2 )$$

Every component except the combustor is assumed to be adiabatic and hence Q=0. The power required by an adiabatic compressor and turbine are determined based on the mass flow rate and enthalpy.

$${\dot{W}}_{c} = {\dot{m}}_{a} ( {h}_{t 1} - {h}_{t 2} ) \qquad ( 3.3 )$$

$${\dot{W}}_{T} = ( {\dot{m}}_{a} + {\dot{m}}_{f} ) ( {h}_{t 3} - {h}_{t 4} ) \qquad ( 3.4 )$$

The emphasis of this section is the analysis of turbomachines and hence, the state variables are calculated at the Compressor Inlet, Compressor exit, Turbine inlet and Turbine exit.

### Compressor Stage Parameters Computations

The ambient conditions at the beginning of every run at the specified RPM are recorded for the inlet conditions of temperature and pressure. At the compressor inlet, the pressure, velocity, Mach number, momentum, mass flow rate are calculated along with the enthalpy.

$${pt}_{1} = {p}_{0} = {p}_{static 1} + {p}_{dynamic 1} \qquad ( 3.5 )$$

$${pt}_{1} = {p}_{0} = {p}_{static 1} + \frac{1}{2} {ρ}_{0} {u}_{1}^{2} \qquad ( 3.6 )$$

$${u}_{1} = \sqrt{\frac{2 {p}_{dynamic 1}}{{ρ}_{0}}} \qquad ( 3.7 )$$

$$M = \frac{{u}_{1}}{\sqrt{γ {RT}_{1}}} \qquad ( 3.8 )$$

$${\dot{m}}_{1} = {ρ}_{0} {A}_{1} {u}_{1} = {ρ}_{0} {\dot{u}}_{1} \qquad ( 3.9 )$$

$${F}_{1} = {\dot{m}}_{1} {u}_{1} \qquad ( 3.1 )$$

$${h}_{1} = {c}_{p} {T}_{1} \qquad ( 3.11 )$$

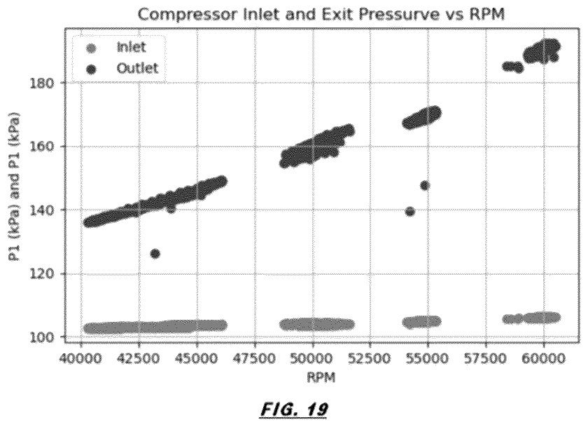

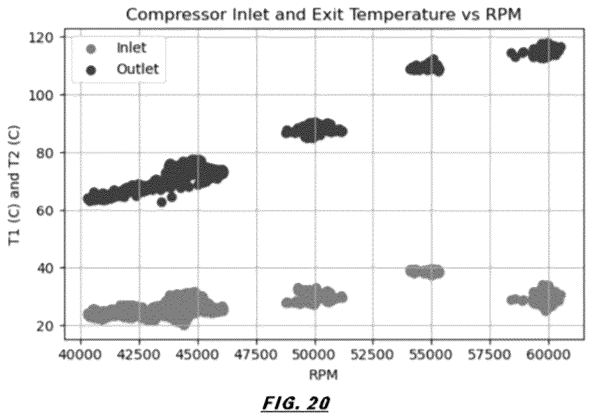

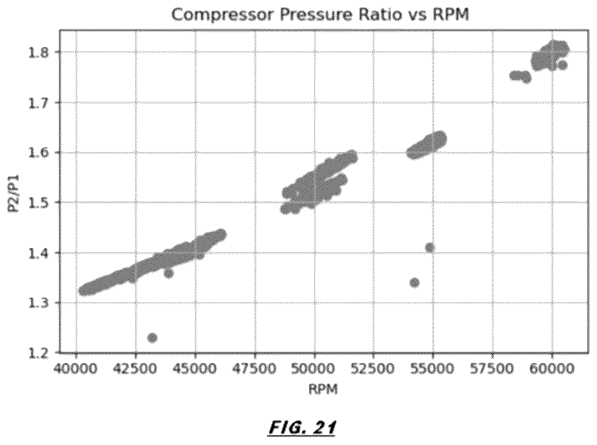

The operational data for the Jet-A fuel between 40000-65000 is shown here. There were vibration issues recorded over 65000 RPM cause the fuel leak at the Turbine Exit and hence, the experiment for Jet-A was conducted till 65000 RPM. FIGS. 19 and 20 depict the operational pressures and temperatures of centrifugal compressor.

At the exit of the compressor, neglecting kinetic energy due to the low velocities u₂≈0; the state pressure and temperature variables are computed.

$${p}_{t} otal 2 = {p}_{static 2} + {p}_{dynamic 2} \qquad ( 3.12 )$$

$${p}_{t} otal 2 = {p}_{static 2} + \frac{1}{2} {ρ}_{0} {u}_{2}^{2} = {p}_{static 2} \qquad ( 3.13 )$$

$${T}_{2} = {T}_{2} + \frac{{u}_{2}^{2}}{2 {c}_{p}} \approx {T}_{2} \qquad ( 3.14 )$$

$${h}_{2} = {c}_{p} {T}_{2} \qquad ( 3.15 )$$

In order to compute the isentropic conditions, compressor work is calculated as shown and the isentropic efficiency is calculated.

$${T}_{2 , is} = {{T}_{1} ( \frac{{p}_{2}}{{p}_{1}} )}^{\frac{γ - 1}{γ}} \qquad ( 3.16 )$$

$${h}_{2 , is} = {c}_{p} {T}_{2 , is} \qquad ( 3.17 )$$

$${η}_{is , comp} = \frac{{w}_{comp , is}}{{w}_{comp}} \qquad ( 3.18 )$$

$${η}_{is , comp} = \frac{{h}_{2 , is} - {h}_{1}}{{h}_{2} - {h}_{1}} \qquad ( 3.19 )$$

### Turbine Stage Parameters Computations

Similar to computations conducted for the compressor to obtain the stage-wise parameters of temperature, pressure and efficiency, thermodynamic computations for the turbine are conducted using the equations below.

$${h}_{3} = {c}_{p} {T}_{3} \qquad ( 3.2 )$$

$${h}_{4} = {c}_{p} {T}_{4} \qquad ( 3.21 )$$

$${T}_{4 , is} = {{T}_{3} ( \frac{{p}_{4}}{{p}_{3}} )}^{\frac{γ - 1}{γ}} \qquad ( 3.22 )$$

$${h}_{4 , is} = {c}_{p} {T}_{4 , is} \qquad ( 3.23 )$$

$$- {w}_{turb} = {h}_{4} - {h}_{3} \qquad ( 3.24 )$$

$${η}_{is , turb} = \frac{{w}_{turb}}{{w}_{turb , is}} \qquad ( 3.25 )$$

$${η}_{is , turb} = \frac{{h}_{4} - {h}_{3}}{{h}_{4 , is} - {h}_{3}} \qquad ( 3.26 )$$

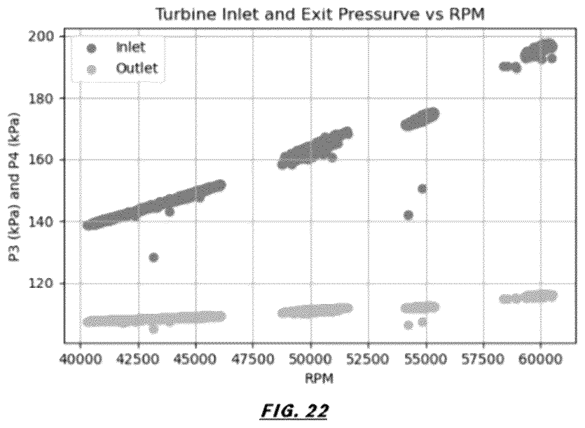

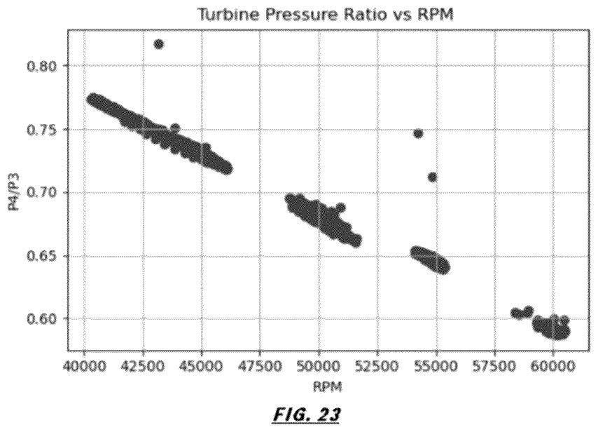

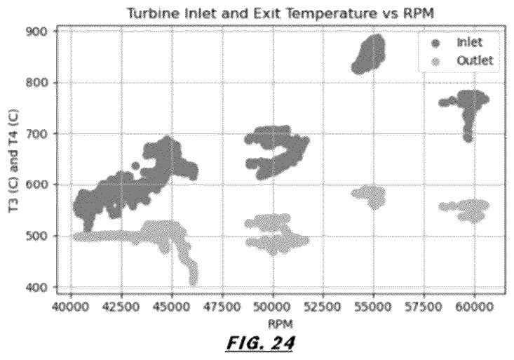

Due to the vibration issues recorded over 55000 RPM, we can observe anomalies in the experimental data. Hence, it is crucial to include such uncertainties in the machine learning models; which will enable the fault diagnostics as well as engine health monitoring. FIGS. 22-24 depict the operational pressures and temperatures of axial compressor along with the uncertainties.

### Overall Thrust Computation

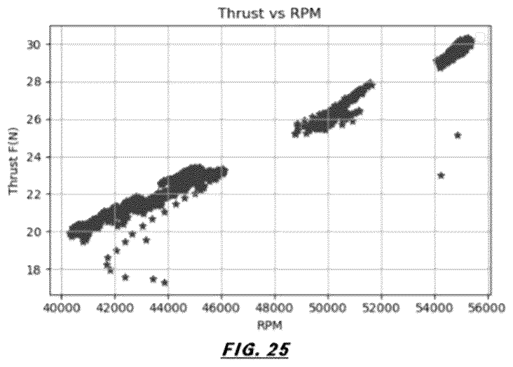

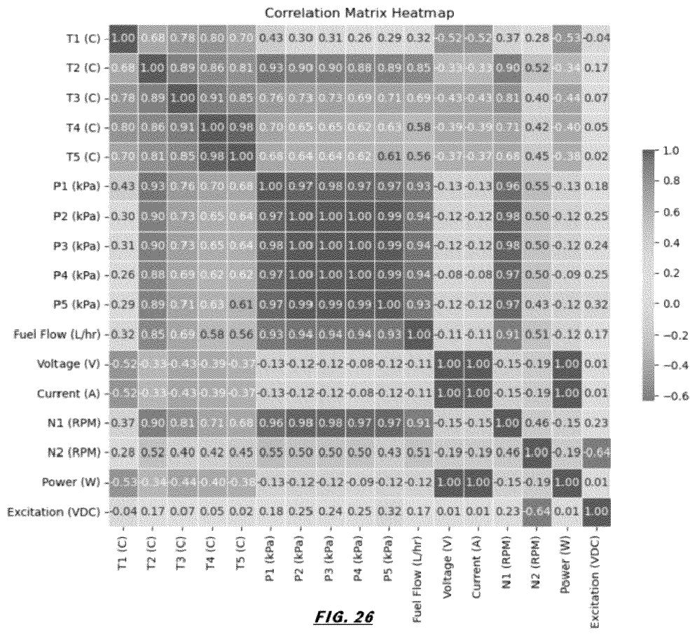

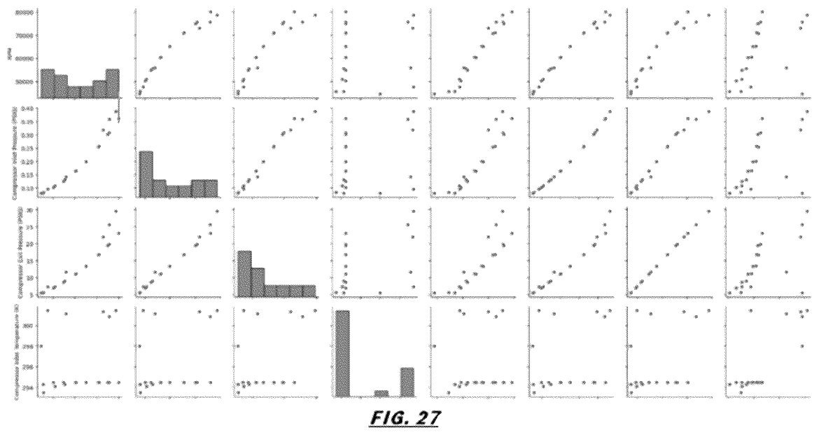

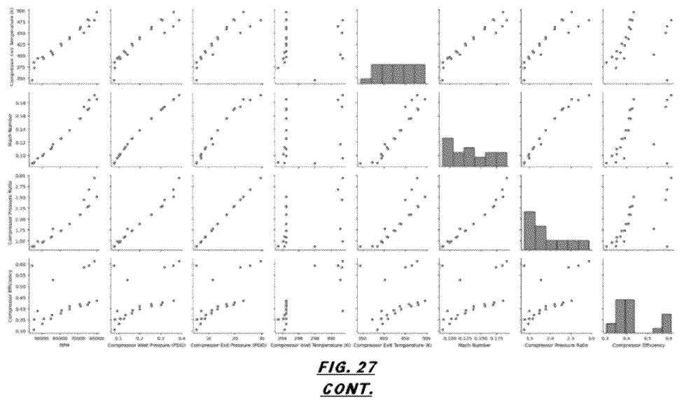

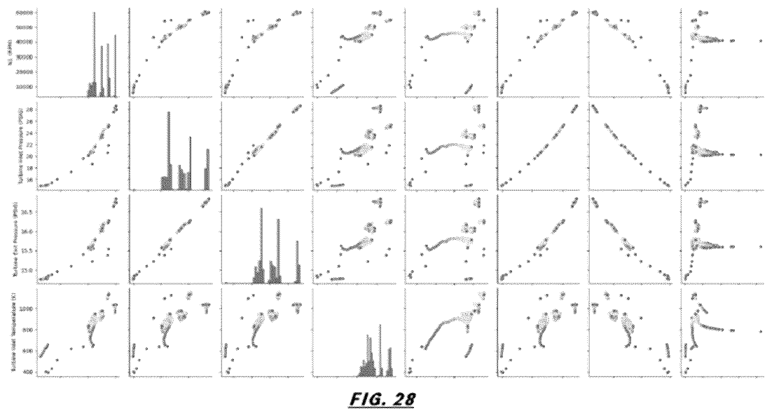

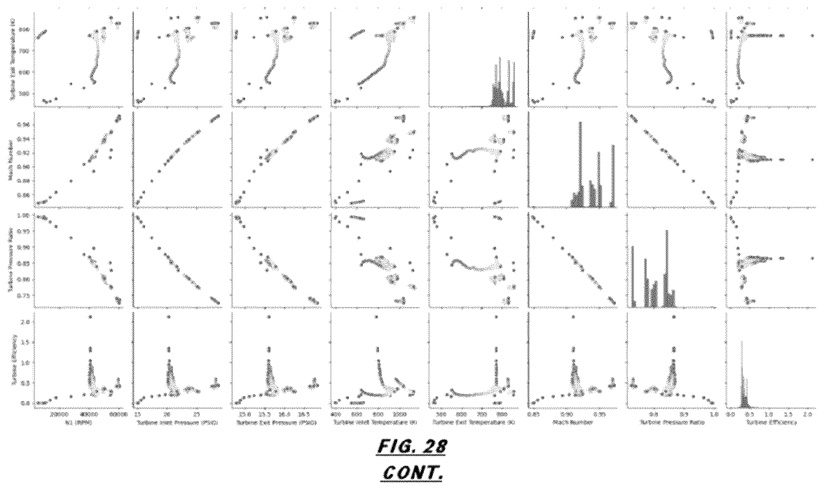

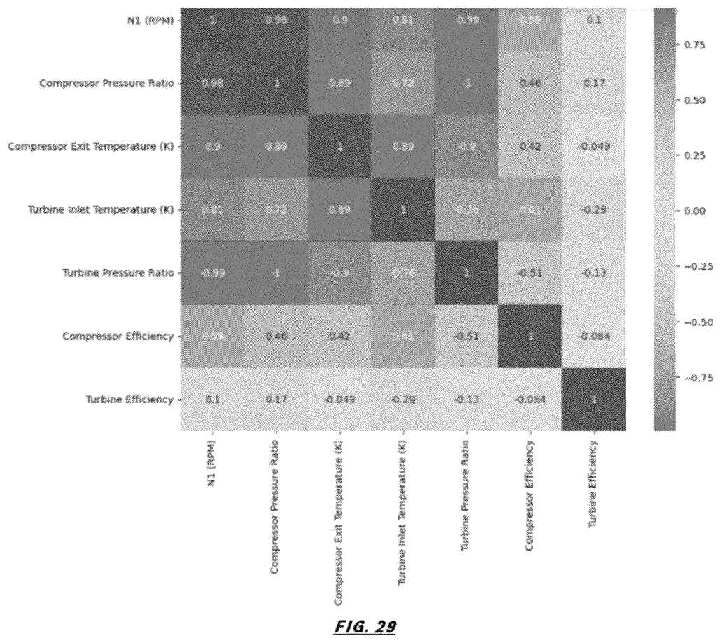

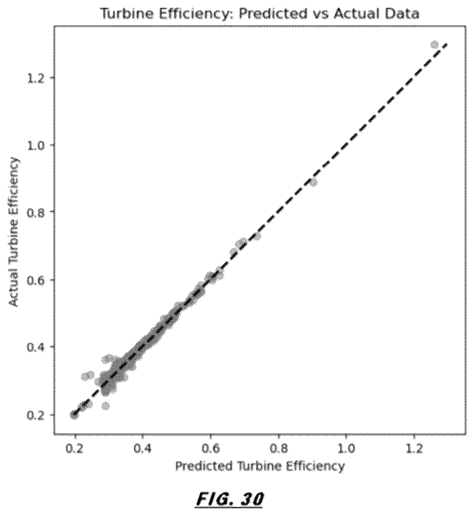

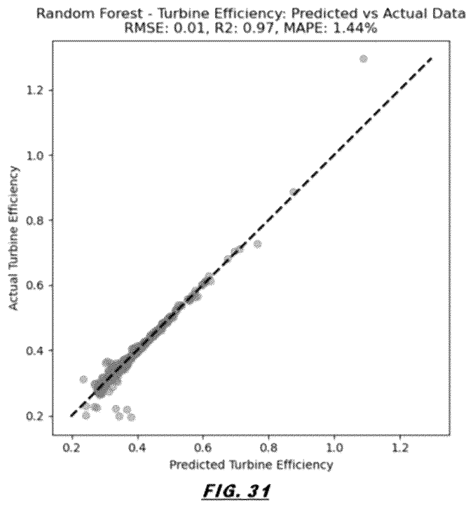

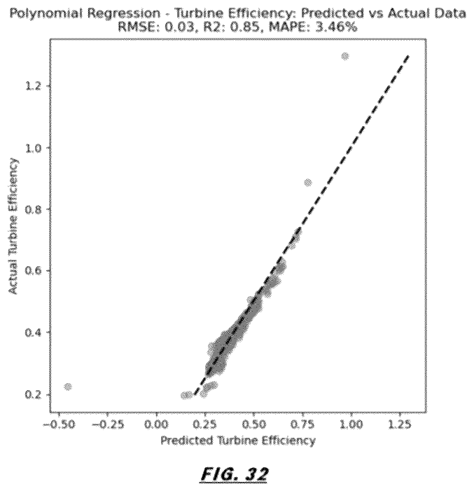

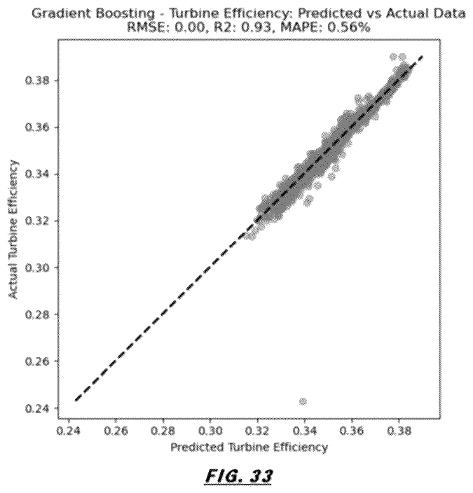

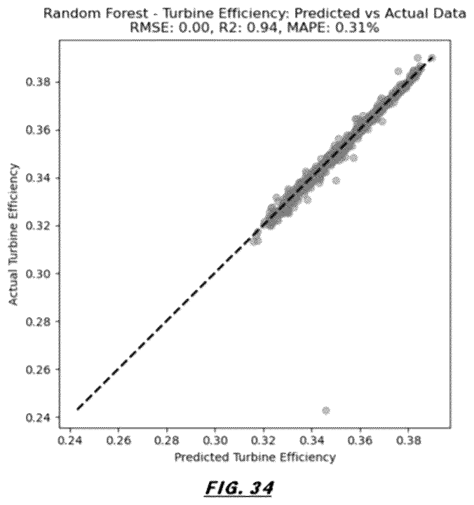

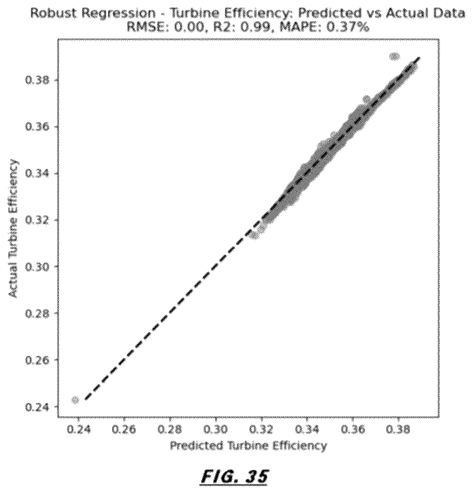

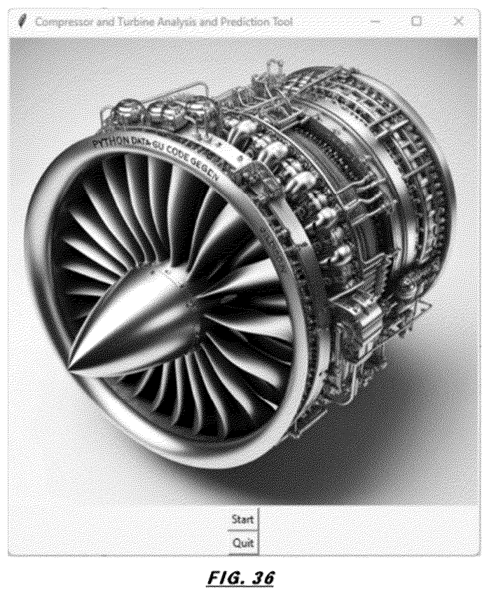

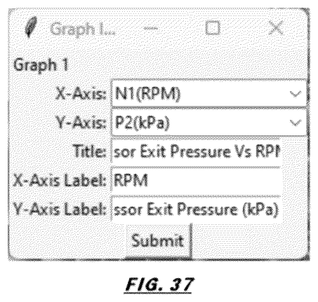

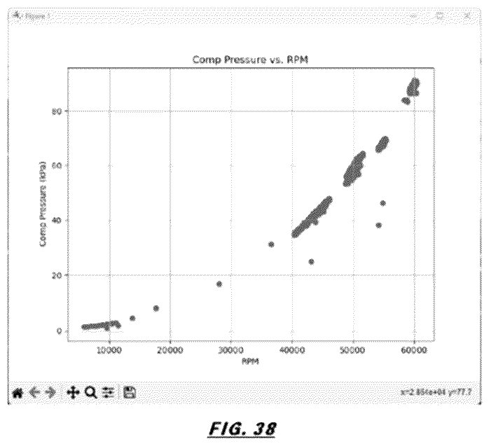

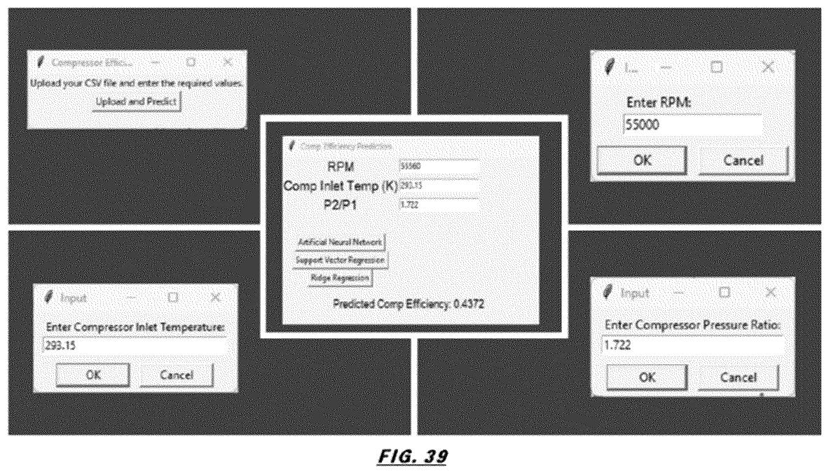

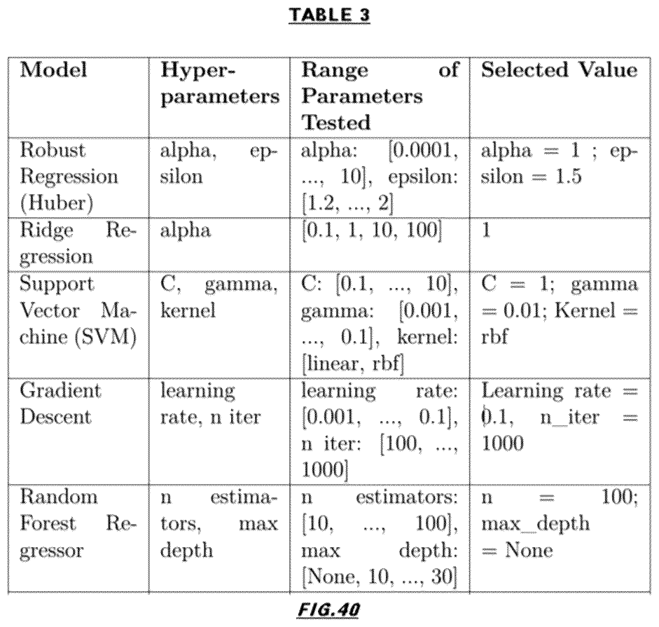

To compute the overall thrust of the SR-30 GTE, the mass flow rate is calculated by the summation of mass of air flow and mass of the fuel. The net thrust is calculated by the difference of thrust between the turbine exit and the compressor inlet. FIG. 25 depicts the overall thrust calculated within the operational regime 40000-65000 RPM.

$${\dot{m}}_{total} = {\dot{m}}_{air} + {\dot{m}}_{fuel} \qquad ( 3.27 )$$

$${F}_{exit} = {\dot{m}}_{exit} {u}_{exit} \qquad ( 3.28 )$$

$${F}_{net} = {F}_{exit} - {F}_{inlet} \qquad ( 3.29 )$$

$${F}_{net} = {\dot{m}}_{exit} {u}_{exit} - {\dot{m}}_{inlet} {u}_{inlet} \qquad ( 3.3 )$$

### Machine Learning Methodology

The following section outlines the machine learning methodologies employed to understand the behaviors of GTE and thereby predict the performance in the steady state and the transient conditions, To conduct gas turbine performance prediction, it is important to assess the ability of the ML models to accurately predict unseen data and handle complex patterns. In this section, to understand the linear and non-linear relationships between RPM, pressure ratios, temperatures, fuel flow rate and the like to the component and overall efficiency of the SR-30 GTE, 8 different models are compared. Linear regression provides simplicity and interpretability but may struggle with nonlinear relationships, while polynomial regression offers more flexibility but can be prone to overfitting. Ridge regression addresses overfitting and multi-collinearity concerns. Random forest regression combines multiple decision trees and exhibits robustness but may be challenging to interpret. SVM regression aims to find a hyperplane with maximum margin, handling nonlinear relationships but requiring careful hyperparameter selection. Stochastic gradient descent regression optimizes iteratively, making it efficient for large datasets but potentially converging to suboptimal solutions. Artificial neural network regression captures complex relationships but requires careful architecture and hyperparameter tuning. XGBoost regression, known for its scalability and effectiveness in handling sparse data, employs gradient boosting techniques to optimize decision trees, making it powerful for capturing non-linear relationships, but it requires careful tuning of parameters and may overfit with excessive depth. NARX (Nonlinear AutoRegressive model with exogenous inputs) regression, particularly suitable for time-series forecasting, leverages past values of the target variable and external inputs to predict future values, capturing dynamic nonlinearities effectively, but it demands a proper selection of lagged values and can be computationally intensive for long series. In summary, the choice of model should consider the trade-offs between interpretability, flexibility, robustness, and computational efficiency for successful generalization in gas turbine performance prediction tasks. Various machine learning models used in studying the underlying relationships between the component pressure and temperature in relation to the RPM of the engine are described in the section below. The objective is to accurately predict the efficiency of compressor and turbine based on physics-based data-driven models.

### Data Preparation and Model Validation

The initial dataset containing over 8000 data points from the experiments conducted at Midlands Tech is cleaned to eliminate any anomalies caused by sensor malfunction, negative values, etc., to yield 6228 refined operational data points. In order to include the entire operational range of SR-30 GTE, data from experiments conducted by other researchers around the world is included to generate accurate performance prediction models. The data set is split into 80%-20% training and testing ratio. 10 fold cross-validation (CV) is conducted on the training data to improve the accuracy and reliability. The training and the testing datasets are standardized and normalized to prevent any inherent bias, anomalies. The accuracy of the ML models developed are evaluated by R-squared score (Coefficient of Determination), RMSE (Root Mean Squared Error), MSE (Mean Squared Error), and MAPE (Mean Absolute Percentage Error) given by the equations below.

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - \overline{y} )}^{2}} \qquad ( 3.31 )$$

where yᵢ is the actual value, [symbol] ᵢ is the predicted value, [symbol] is the mean of actual values,

and n is the number of data points.

$$RMSE = \sqrt{\frac{1}{n} {\sum }_{i = 1}^{n} {( {y}_{i} - {\hat{y}}_{i} )}^{2}} \qquad ( 3.32 )$$

where yᵢ is the actual value, [symbol] ᵢ is the predicted value, and n is the number of data points.

$$MSE = \frac{1}{n} {\sum }_{i = 1}^{n} {( {y}_{i} - {\hat{y}}_{i} )}^{2} \qquad ( 3.33 )$$

where yᵢ is the actual value, [symbol] ᵢ is the predicted value, and n is the number of data points. The MAPE (Mean Absolute Percentage Error) is defined as:

$$MAPE = \frac{1}{n} {\sum }_{i = 1}^{n} \vert \frac{{y}_{i} - {\hat{y}}_{i}}{{y}_{i}} \vert \times 100 \% \qquad ( 3.34 )$$

where yᵢ is the actual value, [symbol] ᵢ is the predicted value, and n is the number of data

### Correlation of Operational Parameters

Two different correlation matrices are developed for operational data from the experiment and the combined data of all experiments, historical, and data from literature. This process is critical to enable the fundamental understanding and the relationship between the input variable and the quantities of interest (such as Compressor Efficiency). The correlation matrix is developed for the operational variables and the computed efficiency values highlight the distribution of temperature, pressure across various operational RPM's.

### Machine Learning Models and Descriptions

The Graphical User Interface (GUI) created to accurately depict the non-linear relationship and characteristics of the operational parameters enables the use of 8 different models and provides the user a choice to pick 3 top models based on computation time and memory usage. The following section provides a brief description of these models.

### Linear Regression

Linear regression is a supervised learning algorithm utilized for modeling the relationship between independent variables and a continuous target variable. It aims to determine a linear equation of the form:

$$y = mx + c \qquad ( 3.35 )$$

where y represents the predicted output, x represents the input feature vector, m denotes the coefficient or weight assigned to each feature, and c represents the bias or intercept term. The objective is to find the optimal values for m and c by minimizing the sum of squared differences between the predicted values and the actual target values. This optimization process, often achieved through techniques like ordinary least squares which allows linear regression to approximate the underlying linear relationship between the variables and make accurate predictions.

### Polynomial Regression

Polynomial regression is a form of regression analysis that models the relationship between the independent variable(s) and the dependent variable using polynomial functions. The general equation for polynomial regression can be expressed as:

$$y = {β}_{0} + {β}_{1} x + {β}_{2} {x}^{2} + {β}_{3} {x}^{3} + … + {β}_{n} {x}^{n} + ε \qquad ( 3.36 )$$

where y represents the dependent variable, x denotes the independent variable, β₀, β₁, β₂, . . . , βₙ are the coefficients associated with each term, n represents the degree of the polynomial, and & is the error term or residual. By including higher-order terms (e.g., x₂, x₃, . . . , xₙ), the model can capture curvature and nonlinear patterns in the data acquired from experiments and from other literature for SR-30 GTE.

### Ridge Regression

Ridge regression is a regularization technique used in linear regression to mitigate the problem of multicollinearity. It introduces a penalty term to the linear regression equation. The equation for ridge regression can be expressed as to minimize:

$$( \sum {( {y}_{i} - {β}_{0} - \sum {β}_{j} {x}_{ji} )}^{2} + α \sum {β}_{j}^{2} ) \qquad ( 3.37 )$$

Where Σ represents the sum, yᵢ is the observed target value, β₀ is the bias term, βj represents the coefficients, and α is the regularization parameter. The regularization parameter α determines the extent of the penalty. A higher a value increases the penalty and shrinks the coefficients towards zero, reducing their magnitudes and the overall complexity of the model. By including the regularization term, ridge regression reduces the impact of multicollinearity and provides more stable and reliable estimates of the regression coefficients. It helps prevent overfitting by balancing the model's fit to the training data and its complexity, leading to improved generalization prediction performance of component level efficiency.

### Robust Regression

Robust regression is designed to mitigate the influence of outliers. One approach is M-estimation, which involves minimizing a robust loss function. minimize

$$minimize {\sum }_{i = 1}^{n} ρ ( {r}_{i} ) \qquad ( 3.38 )$$

where ρ is a robust loss function, ri represents the residual error for the i-th data point, and n is the number of observations. Unlike traditional least squares regression, robust regression loss functions such as Huber's loss or Tukey's biweight function assign lower weights to outlier observations, thereby reducing their impact on the model estimation. The equation for robust regression can be expressed as to minimize Σρ(rᵢ), where ρ denotes the robust loss function, and ri represents the residual error for each data point.

### Random Forest Regression

Random forest regression uses an ensemble of decision trees. The general equation can be expressed as:

$$y = f ( X ) + ε \qquad ( 3.39 )$$

where y is the predicted output, X denotes the input feature vector, f(X) is the ensemble of decision trees' predictions, and ε is the error term. In random forest regression, the algorithm creates an ensemble of decision trees, each trained on a random subset of the data and a random subset of input features. Each decision tree independently predicts the output based on the input features. The final prediction is obtained by aggregating the predictions of all the individual decision trees. This aggregation can be performed by taking the average (for continuous output) or majority voting (for discrete output) of the individual tree predictions. The strength of random forest regression lies in its ability to handle complex relationships and interactions between input features. It can capture nonlinearity, handle high-dimensional data, and deal with noisy or missing data. Additionally, it provides estimates of feature importance, which is critical as the evaluating and reducing the higher dimensional data, thus allowing for insights into the relative contribution of different features in the regression task

### Support Vector Machine (SVM) Regression

SVM regression aims to find a hyperplane that best fits the data. The equation can be expressed as:

$$y = {w}_{0} + {w}_{1} {x}_{1} + {w}_{2} {x}_{2} + … + {w}_{p} {x}_{p} + ε \qquad ( 3.4 )$$

where y is the predicted output, x₁, x₂, . . . , xₚ are the input features, w₀, w₁, w₂, . . . , wₚ are the coefficients, and ε is the error term. In SVM regression, the objective is to find the optimal values for the coefficients w₀, w₁, w₂, . . . , wₚ that minimize the sum of the errors or residuals while satisfying a certain margin or constraint. The margin represents the region around the hyperplane where the data points lie. The algorithm identifies support vectors, which are the data points that lie closest to the hyperplane or violate the margin constraint. These support vectors play a crucial role in determining the position and orientation of the hyperplane. The goal is to minimize the errors or residuals while keeping the margin as wide as possible. SVM regression often uses a kernel function to map the input features into a higher-dimensional space, enabling the algorithm to capture nonlinear relationships. Common kernel functions include linear, polynomial, radial basis function (RBF), and sigmoid. By finding the optimal hyperplane that maximizes the margin while minimizing the errors, SVM regression provides a robust and flexible approach for regression tasks. It can handle high-dimensional data, handle outliers, and generalize well to unseen data.

### Stochastic Gradient Descent (SGD) Regression

SGD regression iteratively updates the model parameters. The equation for SGD regression can be expressed as:

$$w ← w - α ∇ Q ( w ) \qquad ( 3.41 )$$

where w represents the model parameters, a is the learning rate, and ∇Q(w) is the gradient of the loss function. In SGD regression, the objective is to minimize a loss function Q(w) that quantifies the difference between the predicted values and the actual target values. The loss function can vary depending on the specific regression problem, but commonly used ones include mean squared error (MSE) and mean absolute error (MAE). At each iteration, SGD randomly selects a small batch from the training set with various combinations. It computes the gradient of the loss function with respect to the model parameters, which indicates the direction of steepest descent. The model parameters are then updated by subtracting the product of the learning rate and the gradient from the current values. This process is repeated for a specified number of iterations or until convergence is achieved. SGD iteratively updates the model parameters, gradually reducing the loss and improving the regression performance. SGD regression is particularly useful for large-scale datasets as it processes only a subset of the data in each iteration, making it computationally efficient.

### Artificial Neural Network (ANN)

ANN consists of interconnected nodes organized in layers. The equations for a single neuron can be expressed as follows:

$$For a hidden layer neuron : z = {w}_{1} {x}_{1} + {w}_{2} {x}_{2} + … + {w}_{p} {x}_{p} + b \qquad ( 3.42 )$$

$$a = f ( z ) \qquad ( 3.43 )$$

$$For an output layer neuron : z = {w}_{1} {a}_{1} + {w}_{2} {a}_{2} + … + {w}_{m} {a}_{m} + b \qquad ( 3.44 )$$

$$y = f ( z ) \qquad ( 3.45 )$$

Here, z represents the weighted sum of inputs x₁, x₂, . . . , x_{P} multiplied by their corresponding weights w₁, w₂, . . . , w_{P} with the addition of a bias term (b). The result of the weighted sum is passed through an activation function f( ) resulting in the neuron's output (a for hidden layers and y for the output layer). Activation functions introduce nonlinearity to the network, allowing it to learn and represent complex relationships in the data. Common activation functions include the sigmoid function, hyperbolic tangent function, or Rectified Linear Unit (ReLU) function. During the training process, the network learns by adjusting the weights and biases to minimize the difference between the predicted output (y) and the true target values. This adjustment is typically done using optimization techniques like backpropagation and gradient descent, which calculate and propagate the gradients through the network to update the parameters. The specific equations and architecture of an ANN can vary greatly depending on factors such as the number of layers, the number of neurons per layer, the activation functions used, and the specific learning algorithm employed for studying the component level performance.

### XGBoost Regression

XGBoost regression employs gradient boosting techniques to optimize decision trees. It aims to capture nonlinear relationships but requires careful tuning of parameters to prevent overfitting.

$${\hat{y}}_{i}^{( t )} = {\hat{y}}_{i}^{( t - 1 )} + η {f}_{t} ( {x}_{i} ) \qquad ( 3.46 )$$

where [symbol] ᵢ^{(t)} is the prediction at iteration t, η is the learning rate, and fₜ(xᵢ) is the output of the decision tree model at iteration t. The objective of XGBoost is to minimize a loss function that measures the difference between the predicted values and the actual target values, while also applying regularization terms to control model complexity.

NARX (Nonlinear AutoRegressive with Exogenous Inputs) Regression

NARX regression is suitable for time-series forecasting, leveraging past values of the target variable and external inputs to predict future values, effectively capturing dynamic non-linearities.

$$y ( t ) = f ( y ( t - 1 ) , y ( t - 2 ) , … , y ( t - n ) , x ( t - 1 ) , x ( t - 2 ) , … , x ( t - n ) ) \qquad ( 3.47 )$$

where y(t) is the current value of the target variable, y(t−1), y(t−2), . . . , y(t−n) are its past values, x(t−1), x(t−2), . . . , x(t−n) are past values of the exogenous input variables, and f represents a nonlinear function, often modeled by a neural network. The dynamic and transient modeling of the SR-30 is conducted using NARX coupled with ANN where hyperparameters such as number of hidden layers, activation function, batch size, epoch, optimizer have been optimized.

### Operational Data Model Development

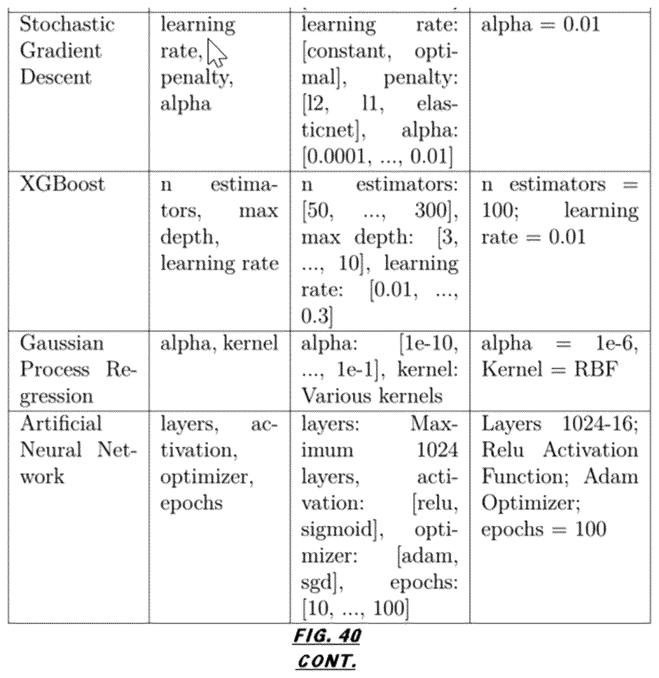

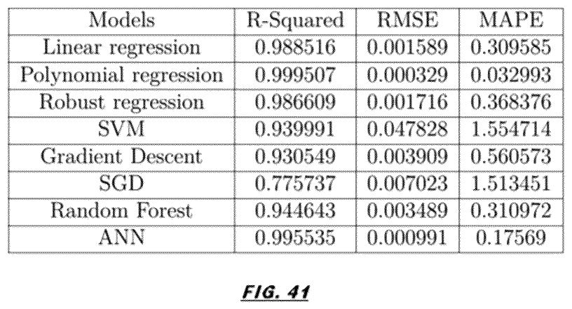

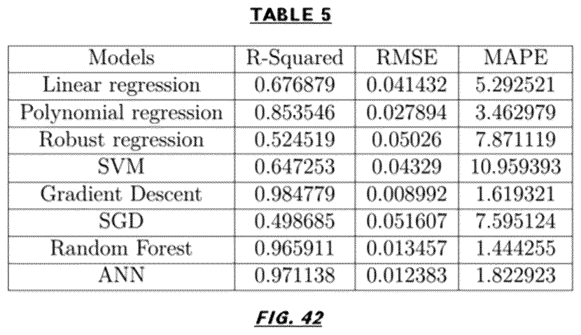

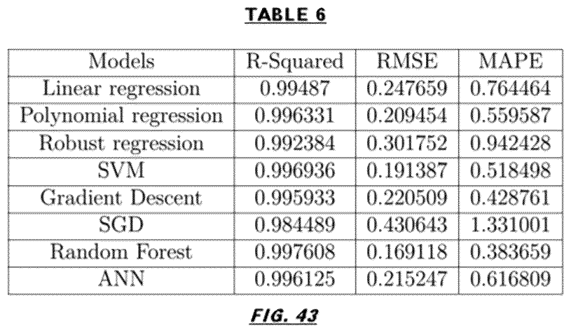

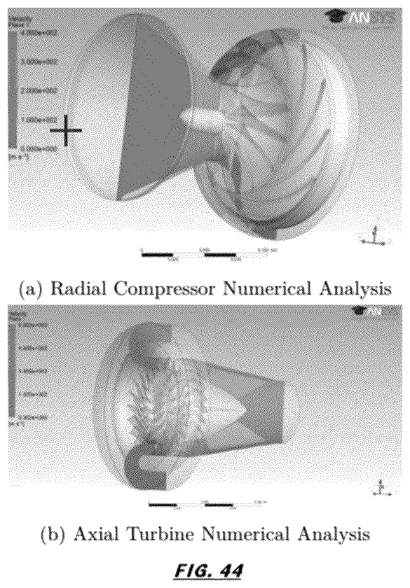

Data from SR-30 experiments, along with student lab results from various universities and findings from academic papers, have been compiled to create an extensive comprehensive dataset. This dataset is utilized for developing machine learning models to predict compressor and turbine efficiency, as well as thrust. In order to create the ML models for prediction various hyper-parameters are tuned using Grid Search CV and Random Search CV based on their applicability. Table 3, see FIG. 40, shows the primary hyper-parameter tuning and optimization conducted.

In this disclosure, the performance of eight distinct predictive models in estimating three key performance metrics are systematically evaluated: Compressor Efficiency, Turbine Efficiency, and Thrust. A comprehensive dataset encompassing 12 operational parameters alongside 11 computationally derived parameters are used for training and testing. Initial observations indicate that when these models are allowed to leverage the entire suite of 23 parameters, they demonstrate a high degree of predictive accuracy. The feature selection is a key metric to evaluate the model performance.

This dataset undergoes a preliminary split into training and testing subsets 80-20 split, adhering to conventional practices in predictive modeling. Subsequently, the models are subjected to cross-validation procedures, and a Standard Scaler to normalize the feature space, thereby mitigating any undue influence of variable scales on the model's performance along with ensuring the model's robustness. A critical step in our methodology is the application of Gradient Boosting for feature importance determination. The rationale for selecting Stochastic Gradient Boosting, in particular, stems from its inherent advantages: it introduces stochasticity in the learning process by subsampling the data, which not only provides a safeguard against overfitting but also enhances the generalizability of the model. This stochastic element, coupled with the gradient boosting framework's ability to iteratively minimize errors, makes it an exemplary tool for discerning the most impactful features in a complex dataset.

Upon completion of the feature importance steps, the models are retrained using the entire dataset to establish a baseline performance metric. Subsequently, predictive performance estimation is conducted by utilizing the top five features as indicated by their importance scores. This comparative analysis allows us to scrutinize the influence of feature selection on model efficiency and accuracy in a controlled manner.

By juxtaposing the models' performance with and without feature selection, we aim to glean insights into the trade-offs between model complexity and predictive accuracy. This investigation not only contributes to a deeper understanding of the models' behavior in the but also provides valuable guidance for future model optimization and feature engineering endeavors.

### Results, Validation and Discussion of Gas Turbine Engine Performance Tool

A comprehensive evaluation of various modeling techniques was conducted to assess their performance in predicting Compressor Efficiency, Turbine Efficiency, and Thrust. The analysis utilized eight distinct modeling approaches: Robust Regression, Ridge Regression, Support Vector Machine (SVM), Gradient Descent, Random Forest, Stochastic Gradient Descent (SGD), XGBoost, Gaussian Process Regression, and Artificial Neural Network (ANN) in addition to the linear and polynomial regression. The models' performance was critically assessed based on three pivotal statistical metrics: R-squared (R2), Root Mean Square Error (RMSE), and Mean Absolute Percentage Error (MAPE).

The analysis of Turbine Efficiency performance was predicted the best by the Polynomial Regression model. It exhibited a near-perfect model fit, as indicated by an R2 value of 0.9995. Additionally, this model achieved the lowest RMSE (0.000329) and MAPE (0.032993), signifying an exceptional prediction accuracy with minimal error variance. The Artificial Neural Network (ANN) also demonstrated significant efficacy, evidenced by an R2 of 0.995535, and comparably low RMSE and MAPE values. While Linear and Robust Regression models yielded high R2 values, they were somewhat less effective in terms of error minimization.

In terms of Compressor Efficiency, the Random Forest and SVM models stood out with the highest R2 values (0.997608 and 0.996936, respectively), suggesting a strong alignment with the observed data. The low RMSE and MAPE scores, particularly in the case of the Random Forest model, indicated a high level of prediction precision and reliability. The Thrust predictions, achieved an overall accuracy of approximately 99 percent across the employed models, demonstrating a high degree of precision. The graphs for the compressor and turbine efficiency prediction validates the mathematical correlation developed for the Compressor Efficiency, Turbine Efficiency, and Thrust. These models developed can be used to hence accurately predict any target performance parameter for the GTEs. They also highlight the optimization of hyper-parameters are required for computationally effective well-trained modeling. A graphical user interface (GUI) is developed to create a user-friendly environment for prediction of compressor and turbine efficiencies and thrust. It leverages the physics based ML models to compute essential parameters based on the operational data. The GUI is designed to receive input of operational parameters, such as temperature and pressure, through Excel or CSV files. It then performs thermodynamic analysis to determine the performance characteristics, which are subsequently used by machine learning algorithms to predict the efficiencies and performance. After the machine learning modeling process is completed in the backend, the system is capable of accepting user inputs, such as RPM, Inlet Temperature, and Pressure for the Compressor, to precisely predict its efficiency.

### SUMMARY

This disclosure focuses on predicting and optimizing the operational efficiency of small-scale GTE, SR-30 by using various machine learning models. The differences in the fuel properties between Jet A and Kerosene attributes to the increased vibrations and restriction of the engine's ability to reach its full RPM range while using Jet A in comparison to experiments with Kerosene. These experiments enable the analysis of the performance parameters and component efficiencies of the compressor and turbine through detailed thermodynamic computations and visualize the interdependent, complex, non-linear nature of the engine's performance. Among the various ML algorithms used for the predicting the turbomachine efficiency and thrust, ANN and XGBoost serve very well along with non-linear regression models with proper hyper-parameter tuning. Additionally, the user-friendly Graphical User Interface developed, serves as a practical tool for predicting the performance efficiency of GTE turbomachines from the operational data, and provides outputs from various ML models and graphical outputs.

For this disclosure, experiments were conducted using SR-30 small scale GTE using Jet-A and Kerosene as fuels in the operational range of 40000-80000 RPM. Thermodynamic computations were conducted using gas path analysis to obtain the efficiencies of the turbomachines. The operational data from the experiments can be used to develop the machine learning models to predict operational efficiencies. A real-time monitoring GUI was developed to obtain the operational parameters for troubleshooting.

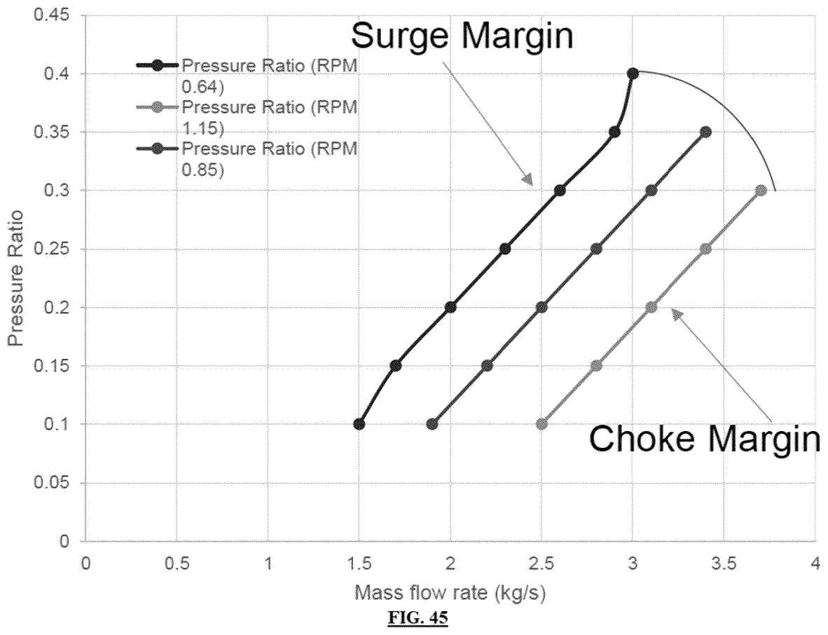

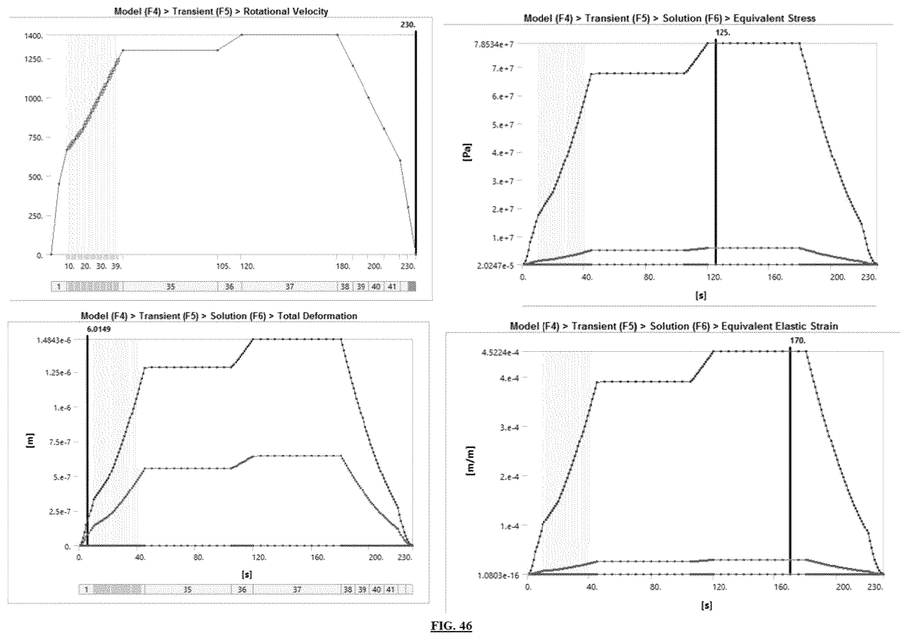

A compressor map of the current disclosure is developed based on parametric study at various mass flow rates, different B, and different RPM ratios. This forms the basis for operational envelop to quantify surge and choke margins. See FIG. 45. FIG. 46 shows graphs of Transient Structural Analysis.

Based on the 600 simulations run with 12 different variables, such as blade-geometric parameters, and ambient conditions, the prediction of single stage component level efficiency and performance parameters of centrifugal compressor and axial turbine is predicted at design and off-design conditions.

Numerical Simulations were conducted using ANSYS-CFX and BLADEGEN for centrifugal compressor, diffuser and axial turbine to numerically compute the efficiencies for compressor and turbine. A mesh independence study was conducted and the experimental validation at design point is with ˜5% variation. A parametric design study was conducted across the operational RPM with various blade designs (including blade angles, hub and shroud diameters) to optimize the flow coefficient and efficiency. Further, methods to directly integrate the output report to ML algorithms have been implemented.

The current disclosure also provides that generic ML methods can be used to effectively predict the performance of GTE at the component and system levels. Physics based ML algorithms have found applicability in reduction of computationally expensive numerical solutions. Indeed, combining the operational data and numerical design parameters creates an iterative design process to optimize the performance of both components and systems.

The current disclosure also provides that Steady and Dynamic performance prediction as well as non-linear characteristics can be captured by hyper-parameter tuning for: Artificial Neural Network; SVM, Robust Regressor; and Nonlinear AutoRegressive with exogenous inputs.

Further, machine learning based 10 different generic models were conducted on the operational data with 13 parameters and numerical data with 12 parameters. Two separate workflow streams were developed to tackle operational data and numerical data successfully integrate to one dataset. Inverse Aerodynamic Design based on Probabilistic Machine learning was used to iterate the component designs for performance prediction.

The current disclosure also provides that GUI was developed to conduct thermodynamic computations based on operational data for compressor and turbine efficiency. The GUI was developed to obtain the various geometrical parameters influencing the centrifugal compressor performance. GUI may also be developed to include the turbine geometrical optimization. Integration of the design modules to have a seamless data flow between numerical and thermodynamic computation may also be achieved. GUI may also be developed for fault diagnostics and emissions data. Here, the GTE-DMT tool has provided more than a 60% reduction in preliminary gas turbine engine development time and an 80% cost reduction.

The current disclosure provides digital twin methods integrating advanced computational algorithms and user-centric interfaces to transform the management of gas turbine engines, which provide comprehensive real-time analytics, extending beyond basic performance prediction, design, analysis and monitoring as well as capabilities for predictive maintenance, design and efficiency optimization, and fault diagnosis, all accessible to operators regardless of their expertise in turbine physics as described and shown herein.

The current disclosure further provides digital twin systems integrating advanced computational algorithms and user-centric interfaces to transform the management of gas turbine engines, which provide comprehensive real-time analytics, extending beyond basic performance prediction, design, analysis and monitoring as well as capabilities for predictive maintenance, design and efficiency optimization, and fault diagnosis, all accessible to operators regardless of their expertise in turbine physics as described and shown herein.

In addition, the current disclosure provides analysis tools and methods employing digital twin systems integrating advanced computational algorithms and user-centric interfaces to transform the management of gas turbine engines, which provide comprehensive real-time analytics, extending beyond basic performance prediction, design, analysis and monitoring as well as capabilities for predictive maintenance, design and efficiency optimization, and fault diagnosis, all accessible to operators regardless of their expertise in turbine physics as described and shown herein.

The following are hereby incorporated by reference:
Forbes, A., “High-Efficiency Gas Turbines Will Play a Growing Role in the Energy Transition,” ge.com/power/transform/article.transform.articles.2018.sep.high-efficiency-gas-turbines, September 2018.
Liu, Z., and Karimi, I. A., “Gas turbine performance prediction via machine learning,” Energy, Vol. 192, 2020, p. 116627. doi.org/10.1016/j.energy.2019.116627, URL sciencedirect.com/science/article/pii/S0360544219323229.
Yucer, C. T., “Thermodynamic analysis of the part load performance for a small-scale gas turbine jet engine by using exergy analysis method,” Energy, Vol. 111, 2016, pp. 251-259. doi.org/10.1016/j.energy.2016.05.108, URL sciencedirect.com/science/article/pii/S0360544216307277.
Singh, R., Maity, A., and Nataraj, P., “Modeling, Simulation and Validation of Mini SR-30 Gas Turbine Engine,” IFACPapersOnLine, Vol. 51, No. 1, 2018, pp. 554-559. doi.org/10.1016/j.ifacol.2018.05.093, URL sciencedirect.com/science/article/pii/S240589631830257X, 5th IFAC Conference on Advances in Control and Optimization of Dynamical Systems ACODS 2018.
Multi-Parametric Model Predictive Control Strategy on Laboratory SR-30 Gas Turbine, Gas Turbine India Conference, Vol. ASME 2015 Gas Turbine India Conference, 2015. doi.org/10.1115/GTINDIA2015-1248, URL doi.org/10.1115/GTINDIA2015-1248.
Mendez, C., Parthasarathy, R., and Gollahalli, S., “Performance and emission characteristics of a small-scale gas turbine engine fueled with ethanol/Jet A blends,” 50th AIAA Aerospace Sciences Meeting including the New Horizons Forum and Aerospace Exposition, 2012, p. 522.
Badami, M., Nuccio, P., Pastrone, D., and Signoretto, A., “Performance of a small-scale turbojet engine fed with traditional and alternative fuels,” Energy Conversion and Management, Vol. 82, 2014, pp. 219-228. doi.org/10.1016/j.enconman.2014.03.026, URL sciencedirect.com/science/article/pii/S0196890414002180.
Badami, M., Nuccio, P., and Signoretto, A., “Experimental and numerical analysis of a small-scale turbojet engine,” Energy Conversion and Management, Vol. 76, 2013, pp. 225-233. doi.org/10.1016/j.enconman.2013.07.043, URL sciencedirect.com/science/article/pii/S0196890413004147.
Zhao, Y.-P., Hu, Q.-K., Xu, J.-G., Li, B., Huang, G., and Pan, Y.-T., “A robust extreme learning machine for modeling a small-scale turbojet engine,” Applied Energy, Vol. 218, 2018, pp. 22-35. doi.org/10.1016/j.apenergy.2018.02.175, URL sciencedirect.com/science/article/pii/S0306261918303088.
Zhao, Y.-P., Tan, J.-F., Wang, J.-J., and Yang, Z., “C-loss based extreme learning machine for estimating power of small-scale turbojet engine,” Aerospace Science and Technology, Vol. 89, 2019, pp. 407-419. doi.org/10.1016/j.ast.2019.04.023, URL sciencedirect.com/science/article/pii/S1270963818319242.
Watanabe, A., Ã-lÃ§ men, S. M., Leland, R. P., Whitaker, K. W., Trevino, L. C., and Nott, C., “Soft computing applications on a SR-30 turbojet engine,” Fuzzy Sets and Systems, Vol. 157, No. 22, 2006, pp. 3007-3024. doi.org/10.1016/j.fss.2006.05.011, URL sciencedirect.com/science/article/pii/S0165011406002314.
Sheng Zhong, S., Fu, S., and Lin, L., “A novel gas turbine fault diagnosis method based on transfer learning with CNN,” Measurement, Vol. 137, 2019, pp. 435-453. doi.org/10.1016/j.measurement.2019.01.022, URL sciencedirect.com/science/article/pii/S0263224119300405.
Nott, C., Ölçmen, S. M., Karr, C. L., and Trevino, L. C., “SR-30 turbojet engine real-time sensor health monitoring using neural networks, and Bayesian belief networks,” AppliedIntelligence, Vol. 26, No. 3, 2007, pp. 251-265. Doi.org/10.1007/s10489006-0017-z, URL doi.org/10.1007/s10489-006-0017-z.
Xie, J., Sage, M., and Zhao, Y. F., “Feature selection and feature learning in machine learning applications for gas turbines: A review,” Engineering Applications of Artificial Intelligence, Vol. 117, 2023, p. 105591. doi.org/10.1016/j.engappai.2022.105591, URL sciencedirect.com/science/article/pii/S0952197622005814.
Callinan, J., and Hikiss, G., “Operating Experience with The Turbine Technologies Sr 30 Turbojet Engine Test System,” 2002 Annual Conference, ASEE Conferences, Montreal, Canada, 2002. peer.asee.org/10481.
LÃConard, O., Thomas, J. P., and Borguet, S., “Ten Years of Experience with a Small Jet Engine as a Support for Education,” Journal of Engineering for Gas Turbines and Power, Vol. 131, No. 1, 2008, p. 012303. doi.org/10.1115/1.2967487, URL doi.org/10.1115/1.2967487.
Development of a Jet Engine Experiment for the Energy Systems Laboratory, ASME International Mechanical Engineering Congress and Exposition, Vol. Advanced Energy Systems, 2003. doi.org/10.1115/IMECE2003-43638, URL doi.org/10.1115/IMECE2003-43638.
White, S., and Strykowski, P., “Characterizing the Performance of The Sr 30 Turbojet Engine,” 2003 Annual Conference, ASEE Conferences, Nashville, Tennessee, 2003. peer.asee.org/11611.
“Turbine Technologies. SR-30 Gas Turbine Engine Operators Manual,” turbinetechnologies.com/educational-labproducts/turbojet-engine-lab, 2019.
Riedeberger, D., “Design, implementation and evaluation of a passive thrust augmentation device for the SR-30 turbojet,” turbinetechnologies.com/Portals/0/pdfs/gas_turbine_tech_sheets/Masters%20Thesis%20Uni%20Stuttgart.pdf, June 2010.
Sowmya Raghu, Jamil Khan, ‘Machine Learning based approach for predicting and optimizing the centrifugal compressor performance’ presented at ASME SHTC2024
Sowmya Raghu, Jamil Khan, ‘Machine Learning based approach for predicting and optimizing the performance of SR-30 small scale gas turbine engine’ presented at AIAA SciTech 2024
Sowmya Raghu, Jamil Khan, ‘Machine Learning based approach for predicting and optimizing the turbomachinery performance of SR-30 small scale gas turbine engine’ to be presented at ICME 2023
Sowmya Raghu, Jamil Khan, ‘SR-30 small scale gas turbine engine digital twin’, Turbo Expo Poster presentation, July 2023
Sowmya Raghu, Jamil Khan, ‘Optimization of Turbomachinery Design in SR-30 small scale gas turbine engine’, Discover UofSC Poster presentation, April 2023
Sowmya Raghu, Roya Rajabi, Robin James, Kevin Huang, Jamil Khan, ‘Performance Comparison of Battery Thermal Management System based on Numerical Simulations’, ASME Summer Heat Transfer Conference, July 2023
Sowmya Raghu, Jamil Khan, ‘Development of Gas Turbine Design and Monitoring Tool (GTE-DMT) for SR-30 small scale gas turbine engine’-AIAA Journal of Propulsion and Power (in preparation)

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A graphical user interface (GUI) for prediction of device efficiencies and thrust comprising:
at least one machine learning module configured to compute essential parameters based on at least one operational data input from at least one device;
wherein the GUI is designed to receive input of at least one operational parameter;
the GUI is configured to perform at least one thermodynamic analysis to determine at least one performance characteristic of the at least one device; and
wherein the at least one performance characteristic is used by at least one machine learning algorithm contained within the at least one machine learning module to predict at least one efficiency factor and at least one performance factor.

2. The GUI for prediction of compressor and turbine efficiencies and thrust of claim 1, wherein the at least one operational parameter is temperature and/or pressure.

3. The GUI for prediction of compressor and turbine efficiencies and thrust of claim 1, wherein the GUI accepts at least one user input including Revolutions Per Minute, Inlet Temperature, and/or Pressure.

4. The GUI for prediction of compressor and turbine efficiencies and thrust of claim 3, wherein the at least one user input is used by the at least one machine learning algorithm to predict efficiency of the at least one device.

5. The GUI for prediction of compressor and turbine efficiencies and thrust of claim 1, wherein the at least one device is at least one compressor and/or at least one turbine.

6. The GUI for prediction of compressor and turbine efficiencies and thrust of claim 1, wherein the GUI is configured to determine at least one geometrical parameter that changes performance of the at least one device.

7. The GUI for prediction of compressor and turbine efficiencies and thrust of claim 1, wherein the GUI provides device geometrical optimization to shape the at least one device to increase the at least one efficiency factor and/or the at least one performance factor.

8. The GUI for prediction of compressor and turbine efficiencies and thrust of claim 1, wherein the GUI provides at least one real-time analytic of the at least one device.

9. The GUI for prediction of compressor and turbine efficiencies and thrust of claim 1, wherein the GUI provides at least one predictive maintenance indicator for the at least one device.

10. The GUI for prediction of compressor and turbine efficiencies and thrust of claim 1, wherein the GUI incorporates at least one digital twin system.

11. A system for prediction of device efficiencies and thrust comprising:
at least one graphical user interface (GUI);
at least one physics based machine learning module configured to compute essential parameters based on at least one operational data input from at least one device;
wherein the GUI is configured to receive input of at least one operational parameter;
the GUI is further configured to perform at least one thermodynamic analysis to determine at least one performance characteristic of the at least one device; and
wherein the at least one performance characteristic is used by at least one machine learning algorithm contained within the at least one physics based machine learning module to predict at least one efficiency factor and at least one performance factor.

12. The system for prediction of device efficiencies and thrust of claim 11, wherein the at least one operational parameter is temperature and/or pressure.

13. The system for prediction of device efficiencies and thrust of claim 11, wherein the GUI accepts at least one user input including Revolutions Per Minute, Inlet Temperature, and/or Pressure.

14. The system for prediction of device efficiencies and thrust of claim 13, wherein the at least one user input is used by the at least one machine learning algorithm to predict efficiency of the at least one device.

15. The system for prediction of device efficiencies and thrust of claim 11, wherein the at least one device is at least one compressor and/or at least one turbine.

16. The system for prediction of device efficiencies and thrust of claim 11, wherein the GUI determines at least one geometrical parameter that changes performance of the at least one device.

17. The system for prediction of device efficiencies and thrust of claim 1, wherein the GUI provides device geometrical optimization to shape the at least one device to increase the at least one efficiency factor and/or the at least one performance factor of the at least one device.

18. The GUI for prediction of compressor and turbine efficiencies and thrust of claim 11, wherein the GUI provides at least one real-time analytic of the at least one device.

19. The GUI for prediction of compressor and turbine efficiencies and thrust of claim 11, wherein the GUI provides at least one predictive maintenance indicator for the at least one device.

20. The GUI for prediction of compressor and turbine efficiencies and thrust of claim 11, wherein the GUI incorporates at least one digital twin system.
